(19) United States
(12) Patent Application Publication
(10) Pub. No.: US 2026/0001315 A1
(43) Pub. Date: Jan. 1, 2026

(54) Liquid Ejecting Head And Liquid Ejecting Apparatus

(71) Applicant: SEIKO EPSON CORPORATION, Tokyo (JP)

(72) Inventors: Yu SHIOZAWA, Shiojiri (JP); Takahiro KANEGAE, Shiojiri (JP)

(21) Appl. No.: 19/250,653

(22) Filed: Jun. 26, 2025

(30) Foreign Application Priority Data
Jun. 27, 2024 (JP) 2024-103538

(51) Int. Cl. B41J 2/045; B41J 2/14

(52) U.S. Cl. CPC B41J 2/04508; B41J 2/0451; B41J 2/04581; B41J 2/14233; B41J 2002/14491

(57) ABSTRACT

A liquid ejecting head includes a pressure chamber that applies a pressure of a liquid for ejecting a liquid from a nozzle when a first piezoelectric element is driven, and a detection chamber in which a second piezoelectric element detects a residual vibration of the pressure of the liquid applied in the pressure chamber. The first piezoelectric element includes a first piezoelectric body, a first upper electrode, a first lower electrode, and a first vibration plate provided below the first lower electrode, the second piezoelectric element includes a second piezoelectric body, a second upper electrode, a second lower electrode, and a second vibration plate provided below the second lower electrode, and a neutral axis of the second piezoelectric element is positioned above a neutral axis of the first piezoelectric element.

The present application is based on, and claims priority from JP Application Serial Number 2024-103538, filed Jun. 27, 2024, the disclosure of which is hereby incorporated by reference herein in its entirety.

### BACKGROUND

### 1. Technical Field

The present disclosure relates to a liquid ejecting head and a liquid ejecting apparatus.

### 2. Related Art

There are known a liquid ejecting head that uses an actuator such as a piezoelectric element to apply pressure to a liquid such as ink in a pressure chamber and ejects the liquid from a nozzle, and a liquid ejecting apparatus such as a printer that uses the liquid ejecting head. In this manner, in the liquid ejecting head, the clogging of the nozzle or the thickening of the liquid can be determined by detecting a residual vibration generated in the liquid in the pressure chamber after the liquid is ejected (for example, refer to JP-A-2019-147363).

The technique of JP-A-2019-147363 is an excellent one that realizes both the drive for liquid ejection and the detection of residual vibration using the same piezoelectric element and the same pressure chamber, but since the piezoelectric element and the pressure chamber are shared, there is a problem that the driving frequency for ejecting is limited when the residual vibration is detected in real time while the ink is ejected, and a sufficient throughput cannot be obtained. It is also conceivable to provide the pressure chamber and the piezoelectric element for performing the detection of residual vibration separately from the pressure chamber and the piezoelectric element for performing the liquid ejection, but it cannot be said that the structure of the piezoelectric element in such a case is sufficiently examined.

### SUMMARY

The present disclosure can be realized as the following aspects or application examples. According to an aspect of the present disclosure, there is provided a liquid ejecting head. The liquid ejecting head includes a pressure chamber that applies a pressure of a liquid for ejecting a liquid from a nozzle when a first piezoelectric element is driven, a second piezoelectric element, and a detection chamber in which the second piezoelectric element detects a residual vibration of the pressure of the liquid applied in the pressure chamber. In the liquid ejecting head, the first piezoelectric element includes a first piezoelectric body, a first upper electrode provided above the first piezoelectric body, a first lower electrode provided below the first piezoelectric body, and a first vibration plate provided below the first lower electrode, the second piezoelectric element includes a second piezoelectric body, a second upper electrode provided above the second piezoelectric body, a second lower electrode provided below the second piezoelectric body, and a second vibration plate provided below the second lower electrode, and a neutral axis of the second piezoelectric element is positioned above a neutral axis of the first piezoelectric element.

According to another aspect of the present disclosure, there is provided a liquid ejecting head as illustrated below. The liquid ejecting head includes a nozzle, a first piezoelectric element, a pressure chamber that applies a pressure for ejecting a liquid from the nozzle when the first piezoelectric element is driven, a second piezoelectric element, and a detection chamber in which the second piezoelectric element detects a residual vibration of the pressure applied in the pressure chamber. In the liquid ejecting head, the first piezoelectric element includes a first piezoelectric body, a first upper electrode provided above the first piezoelectric body, a first lower electrode provided below the first piezoelectric body, and a first vibration plate provided below the first lower electrode, the second piezoelectric element includes a second piezoelectric body, a second upper electrode provided above the second piezoelectric body, a second lower electrode provided below the second piezoelectric body, and a second vibration plate provided below the second lower electrode, the first vibration plate includes a first insulating layer and a first elastic layer provided below the first insulating layer, and the second vibration plate includes a second insulating layer and a second elastic layer provided below the second insulating layer. Here, when a ratio of a sum of thicknesses of the first piezoelectric body and the first insulating layer to a thickness of the first elastic layer is defined as a first ratio, and a ratio of a sum of thicknesses of the second piezoelectric body and the second insulating layer to a thickness of the second elastic layer is defined as a second ratio, the second ratio is greater than the first ratio.

### BRIEF DESCRIPTION OF THE DRAWINGS

FIG. 1 is an exploded perspective view illustrating a liquid ejecting head according to an embodiment.

FIG. 2 is an explanatory diagram illustrating a cross section of the liquid ejecting head taken along the line II-II in FIG. 1 together with other members configuring the liquid ejecting apparatus.

FIG. 3 is a plan view illustrating a part of a communication plate according to a first embodiment.

FIG. 4 is a plan view illustrating a part of a pressure chamber substrate according to the first embodiment.

FIG. 5 is an explanatory diagram illustrating a schematic configuration of a vibration absorption portion and a pressurization portion.

FIG. 6 is an enlarged explanatory diagram illustrating the pressurization portion and a lead wiring portion.

FIG. 7 is an explanatory diagram illustrating a schematic configuration of a vibration detection portion.

FIG. 8 is an explanatory diagram illustrating an example of wiring from a flexible wiring substrate to each piezoelectric element.

FIG. 9 is an explanatory diagram illustrating a comparison of a form of a piezoelectric element in the pressurization portion and a form of a piezoelectric element in the vibration detection portion according to the first embodiment.

FIG. 10A is an explanatory diagram schematically illustrating a position of a neutral axis of the piezoelectric element of the pressurization portion.

FIG. 10B is an explanatory diagram schematically illustrating a position of a neutral axis of the piezoelectric element of the vibration detection portion.

FIG. 11 is a graph illustrating an example of a drive signal applied to a first piezoelectric element and a detection signal corresponding to a residual vibration generated in ink due to the drive signal.

FIG. 12 is an explanatory diagram illustrating a modification example according to the first embodiment.

FIG. 13 is an explanatory diagram illustrating a comparison of a form of a piezoelectric element in a pressurization portion and a form of a piezoelectric element in a vibration detection portion according to a second embodiment.

FIG. 14 is an explanatory diagram illustrating a comparison of a form of a piezoelectric element in a pressurization portion and a form of a piezoelectric element in a vibration detection portion according to a third embodiment.

FIG. 15 is an explanatory diagram illustrating a comparison of a form of a piezoelectric element in a pressurization portion and a form of a piezoelectric element in a vibration detection portion according to a fourth embodiment.

FIG. 16 is an explanatory diagram illustrating an example of the liquid ejecting apparatus.

### DESCRIPTION OF EMBODIMENTS

### A. Schematic Configuration of Liquid Ejecting Head

### A1 Entire Configuration

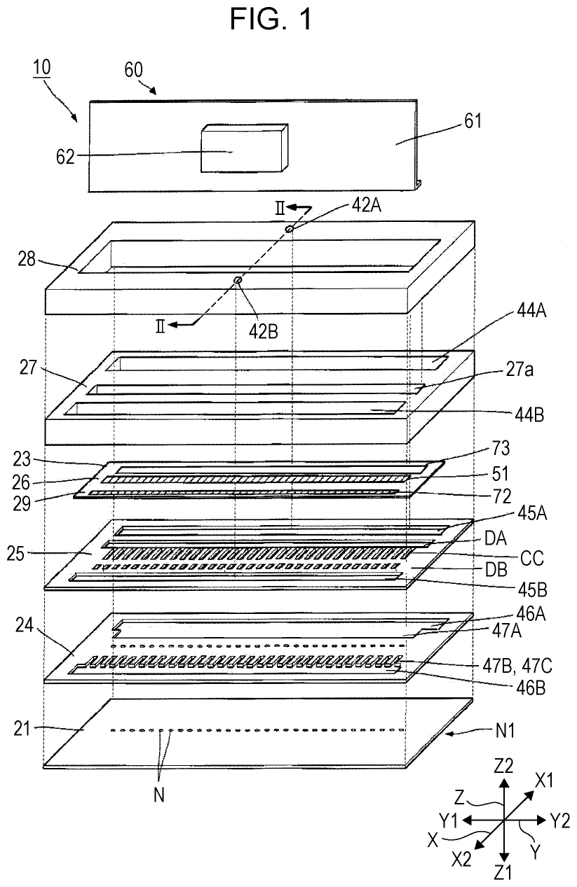

Before the description of each embodiment described later, the configuration of each part common to a liquid ejecting head 10 of the embodiment will be described with reference to FIGS. 1 to 8. In each drawing, the dimensions and scale of each part are prioritized for convenience of understanding, and may differ from the actual ones. The embodiments described below are preferred specific examples of the present disclosure, and thus various technical preferences are limited. However, the scope of the present disclosure is not limited to these embodiments unless otherwise specified in the following description. In addition, in the present specification, sending out a liquid from a nozzle or the like to the outside is referred to as “ejecting”. The ejecting includes various aspects in which a predetermined amount of liquid is ejected to the outside, such as ejection, jetting, spraying, discharge, and intermittent ejecting, regardless of the type of liquid, the ejecting time, the number of times, and the like.

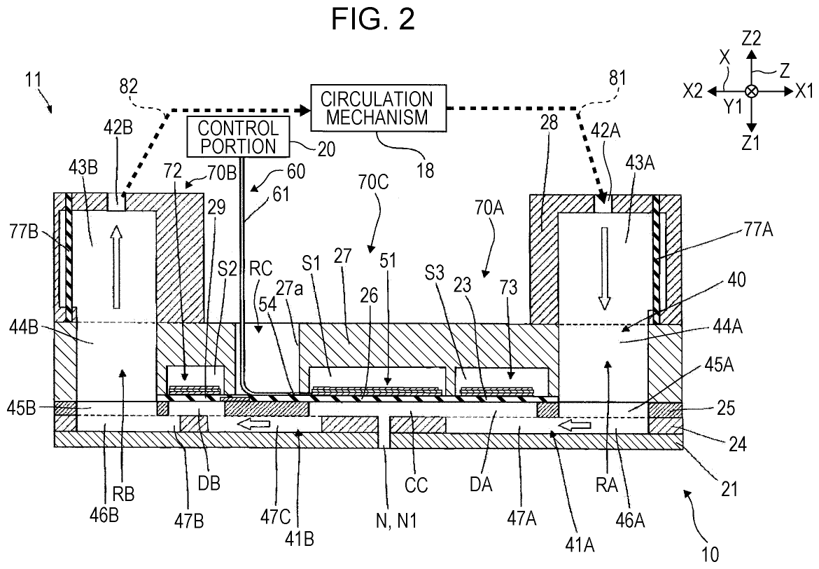

FIG. 1 is an exploded perspective view of a liquid ejecting head 10, and FIG. 2 is a cross-sectional view on the X-Z plane including the line II-II illustrated in FIG. 1, and a cross-sectional view passing through one nozzle N. In the embodiment, the liquid ejecting head 10 is configured as a head for ejecting ink in a printer. The ink is guided to the liquid ejecting head 10, and a part thereof is ejected from the nozzle N to the outside, for example, to a printing medium. Since the ink is circulated, the ink not ejected from the nozzle N is discharged from the liquid ejecting head 10. Therefore, in the present specification, the term of “supply side” and “discharge side” may be used. The term of “supply side” indicates upstream from a pressure chamber CC, which will be described later, with respect to a flow path of the liquid. In addition, a part related to upstream from the pressure chamber CC may be referred to as the “supply side”. The term of “discharge side” indicates downstream from the pressure chamber CC with respect to the flow path of the liquid. The term of “discharge side” does not include a nozzle N to be described later. In addition, a part related to downstream from the pressure chamber CC may be referred to as the “discharge side”. The liquid is not limited to ink, and the liquid ejecting head 10 can be configured to eject other liquids.

In the following description, three directions intersecting each other will be described as an X axis direction, a Y axis direction, and a Z axis direction in some cases. The X axis direction includes an X1 direction and an X2 direction which are directions opposite to each other. The Y axis direction includes a Y1 direction and a Y2 direction which are directions opposite to each other. The Y axis direction is a direction in which a plurality of the nozzles N in the liquid ejecting head are arranged as illustrated in FIG. 1. The disposition and the function of the nozzle N will be described later. The Z axis direction includes a Z1 direction and a Z2 direction which are directions opposite to each other. The Z1 direction is a direction in which the liquid is ejected from the nozzle N and is a direction along the gravity direction in the present embodiment, and the downward direction according to gravity coincides with the Z1 direction. The Z2 direction in this case may be referred to as an “upper side” or an “upper direction”, and the Z1 direction may be referred to as a “lower side” or a “downward direction”. The X axis direction is a direction orthogonal to both the Y axis direction and the Z axis direction described above. In the present embodiment, the Z axis direction coincides with an up and down direction following the gravity direction, but the Z axis direction does not necessarily coincide with the gravity direction, and may be set to have a predetermined angle with respect to the gravity direction.

First, a configuration in which a plurality of the substrates are laminated in the entire configuration of the liquid ejecting head will be described with reference to the drawings. As illustrated in FIGS. 1 and 2, the liquid ejecting head 10 is provided with a nozzle substrate 21, a communication plate 24, a pressure chamber substrate 25, a sealing plate 27, and a case 28 in this order from the lowest portion in the Z1 direction along the Z axis direction. The thickness directions of the nozzle substrate 21, the communication plate 24, the pressure chamber substrate 25, the sealing plate 27, and the case 28 are along the Z axis direction. The sealing spaces S1 to S3 are formed to be separated in the X axis direction on the sealing plate 27, and a plurality of the first and second piezoelectric elements 51 and 72 are accommodated in each of the sealing spaces S1 and S2, and a single third piezoelectric element 73 is accommodated in a sealing space S3. The structures of the first to third piezoelectric elements 51, 72, and 73 will be described in detail later, but the first piezoelectric element 51 includes a first vibration plate 26 integrally provided at a position for sealing the sealing space S1, the second piezoelectric element 72 includes a second vibration plate 29 integrally provided at a position for sealing the sealing space S2, and the third piezoelectric element 73 includes a third vibration plate 23 integrally provided at a position for sealing the sealing space S3.

In addition, the liquid ejecting head 10 is provided with a COF 60. The COF is an abbreviation for Chip on Film. The liquid ejecting head 10 is provided with a common liquid chamber RA, a vibration absorption portion 70A, a pressurization portion 70C, a wiring introduction portion RC, a vibration detection portion 70B on the supply side, and a common liquid chamber RB on the discharge side from the supply side as illustrated in FIG. 2 by laminating each substrate such as the nozzle substrate 21 described above. In the vibration absorption portion 70A, the third vibration plate (hereinafter, also referred to as a compliance substrate) 23 is interposed between the sealing plate 27 and the pressure chamber substrate 25. In addition, in the pressurization portion 70C, the first vibration plate 26 is interposed between the sealing plate 27 and the pressure chamber substrate 25, and in the vibration detection portion 70B, the second vibration plate 29 is interposed between the sealing plate 27 and the pressure chamber substrate 25.

The sealing plate 27 is disposed in the Z2 direction of the first vibration plate 26 and the third vibration plate 23. The sealing plate 27 includes an outer portion from the third vibration plate 23 in the X axis direction. The outer portion of the sealing plate 27 in the X axis direction is positioned in the Z2 direction of the pressure chamber substrate 25. The sealing plate 27 covers the third vibration plate 23, the first vibration plate 26, the second vibration plate 29, a plurality of the first piezoelectric elements 51, and the pressure chamber substrate 25. The case 28 is disposed on the sealing plate 27. The first piezoelectric element 51 is provided corresponding to the pressure chamber CC. In FIGS. 1 and 2, the third vibration plate 23, the first vibration plate 26, and the second vibration plate 29 are drawn in a continuous plate shape, but as will be described later, the plate thicknesses of these members are different. This point will be described later.

Next, the structures of the sealing plate 27 and the case 28 will be described. The sealing plate 27 has a rectangular shape when viewed in the Z axis direction. The sealing plate 27 protects the plurality of the first piezoelectric elements 51, a plurality of the second piezoelectric elements 72, and the one third piezoelectric element 73, and reinforces the mechanical strength of the pressure chamber substrate 25, the first vibration plate 26, the second vibration plate 29, and the third vibration plate 23. For example, the sealing plate 27 is adhered to the first vibration plate 26 or the like by an adhesive. The sealing plate 27 is fixed to the pressure chamber substrate 25 via the first vibration plate 26, the second vibration plate 29, and the third vibration plate 23.

The sealing spaces S1 to S3 are formed in the sealing plate 27. A recessed portion is formed on the lower surface of the sealing plate 27. The space formed by the recessed portion is the sealing spaces S1 to S3. Each of the sealing spaces S1 to S3 is formed to be continuous in the Y axis direction. The sealing space S1 is formed to overlap a plurality of the pressure chambers CC when viewed in the Z axis direction. The sealing space S1 accommodates the plurality of the first piezoelectric elements 51. The sealing space S2 is formed to overlap a plurality of the detection chambers (hereinafter, referred to as vibration detection chambers) DB for detecting the vibration of the liquid when viewed in the Z axis direction. The sealing space S2 accommodates the plurality of the second piezoelectric elements 72. The sealing space S3 is formed to overlap an absorption chamber DA for absorbing the vibration of the liquid when viewed in the Z axis direction. The sealing space S3 accommodates the one third piezoelectric element 73 in the present embodiment.

Furthermore, the sealing plate 27 is formed with a flow path 44A included in the common liquid chamber RA and a flow path 44B included in the common liquid chamber RB. The flow paths 44A and 44B are formed to penetrate the sealing plate 27 in the Z axis direction. The flow path 44A is positioned in the X1 direction of the sealing space S3. The flow path 44B is positioned in the X2 direction of the sealing space S2.

The case 28 is positioned in the Z2 direction of the sealing plate 27. The case 28 is formed with a supply port 42A, a discharge port 42B, and flow paths 43A and 43B. The flow path 43A is included in the common liquid chamber RA. The flow path 43A is formed to overlap the flow path 44A of the sealing plate 27 when viewed in the Z axis direction. The supply port 42A communicates with the flow path 43A. The flow path 43B is included in the common liquid chamber RB. The flow path 43B is formed to overlap the flow path 44B of the sealing plate 27 when viewed in the Z axis direction. The discharge port 42B communicates with the flow path 43B.

The compliance substrates 77A and 77B are fixed to the case 28. As illustrated in FIG. 2, the compliance substrates 77A and 77B are provided in the common liquid chambers RA and RB. The compliance substrates 77A and 77B are different from the third vibration plate 23 provided corresponding to a damper chamber DA. In FIG. 2, the compliance substrates 77A and 77B are not exposed to the outside of the liquid ejecting head 10, and the compliance substrates 77A and 77B may be exposed to the outside of the liquid ejecting head 10.

The compliance substrate 77A is provided corresponding to the flow path 43A of the common liquid chamber RA. The compliance substrate 77A is positioned in the X1 direction of the flow path 43A. The compliance substrate 77A is disposed to cover an opening forming the flow path 43A. The thickness direction of the compliance substrate 77A is along the X axis direction. The compliance substrate 77A extends in the Y axis direction.

The compliance substrate 77B is provided corresponding to the flow path 43B of the common liquid chamber RB. The compliance substrate 77B is positioned in the X2 direction of the flow path 43B. The compliance substrate 77B is disposed to cover an opening forming the flow path 43B. The thickness direction of the compliance substrate 77B is along the X axis direction. The compliance substrate 77B extends in the Y axis direction.

The compliance substrates 77A and 77B are preferably made of a material that is more likely to bend than the third vibration plate 23, and may be made of the same material as the third vibration plate 23. The compliance substrates 77A and 77B include elastic layers and insulating layers. For example, the elastic layer is made of silicon dioxide (SiO₂). For example, the insulating layer is made of zirconium dioxide (Zro₂).

The compliance substrate 77A can be deformed by receiving the pressure of the ink in the flow path 43A of the common liquid chamber RA. The compliance substrate 77A is deformed by the pressure of the ink and absorbs the pressure fluctuation of the ink in the flow path 43A of the common liquid chamber RA. Similarly, the compliance substrate 77B can be deformed by receiving the pressure of the ink in the flow path 43B of the common liquid chamber RB. The compliance substrate 77B is deformed by the pressure of the ink and absorbs the pressure fluctuation of the ink in the flow path 43B of the common liquid chamber RB.

### A2 Ink Flow Path

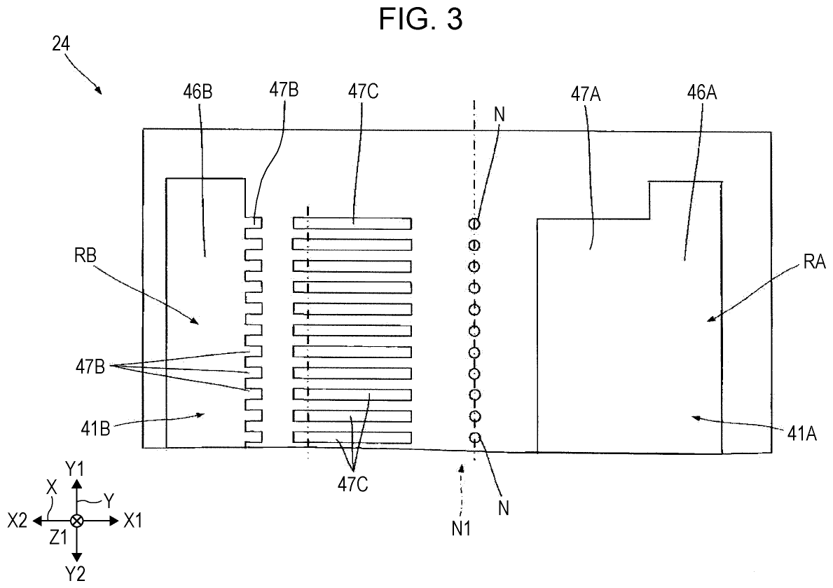

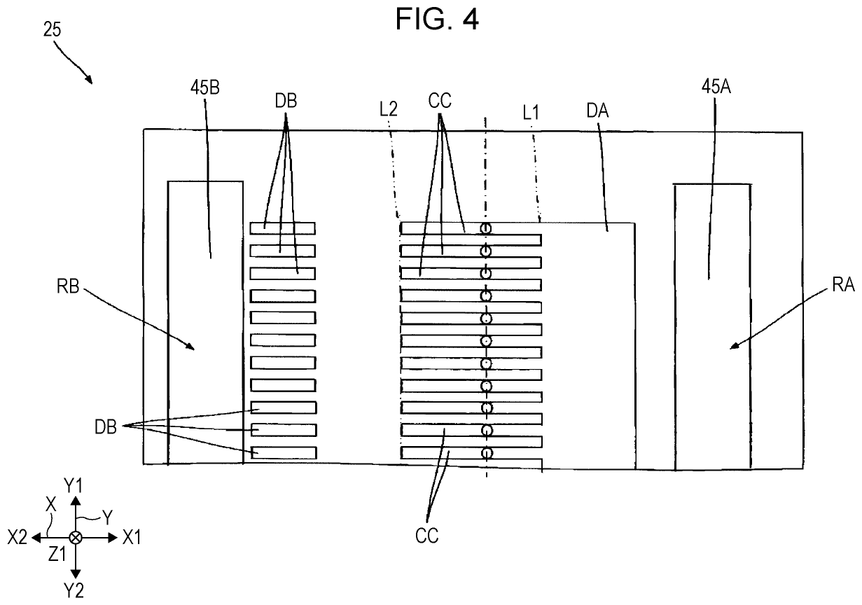

Next, a configuration of a flow path 40 through which the ink flows will be described. The liquid ejecting head 10 is formed with a flow path 40 through which ink flows. The flow path 40 includes a supply port 42A, a discharge port 42B, common liquid chambers RA and RB, a damper chamber DA, a pressure chamber CC, a vibration detection chamber DB, communication flow paths 47A to 47C, and a nozzle N. The flow path 40 includes a plurality of the individual flow paths individually provided corresponding to the nozzles N and a common flow path commonly provided in the individual flow paths. In order to understand these differences, FIG. 3, which is a plan view illustrating a part of the communication plate 24, and FIG. 4, which is a plan view illustrating a part of the pressure chamber substrate 25, are appropriately referred to.

The flow path 40 has a supply flow path 41A and a discharge flow path 41B. The supply flow path 41A is a flow path on upstream from the pressure chamber CC and is a flow path in the communication plate 24 and the pressure chamber substrate 25. The supply flow path 41A includes a flow path 45A, a flow path 46A, and a damper chamber DA. The discharge flow path 41B is a flow path on downstream from the pressure chamber CC and is a flow path in the communication plate 24 and the pressure chamber substrate 25. The discharge flow path 41B includes a communication flow path 47C, a communication flow path 47B, a vibration detection chamber DB, a flow path 46B, and a flow path 45B. The supply flow path 41A does not include the flow path 44A in the sealing plate 27 and the flow path 43A in the case 28. The discharge flow path 41B does not include the flow path 44B in the sealing plate 27 and the flow path 43B in the case 28.

The common liquid chamber RA is commonly provided for the plurality of the pressure chambers CC. The common liquid chamber RA is continuous in the Y axis direction. The common liquid chamber RA includes the flow path 43A provided in the case 28, the flow path 44A provided in the sealing plate 27, the flow path 45A provided in the pressure chamber substrate 25, and the flow path 46A provided in the communication plate 24. The flow paths 43A, 44A, 45A, and 46A are continuous in the Z axis direction.

The communication flow path 47A that is continuous from the supply flow path 41A in the communication plate 24 is disposed downstream of the common liquid chamber RA, and communicates with the common liquid chamber RA via the flow path 46A. As illustrated in FIG. 3, the communication flow path 47A is a common flow path commonly coupled to the flow path 46A. The communication flow path 47A is a common flow path commonly coupled to the plurality of the pressure chambers CC. In the embodiment, the communication flow path 47A is commonly provided for the plurality of the pressure chambers CC, and as long as the pressure fluctuation upstream of the pressure chamber CC can be absorbed, the communication flow path 47A may have another shape such as a form of an individual flow path corresponding to the pressure chamber CC or a form common for several pressure chambers CC.

The damper chamber DA is provided corresponding to the vibration absorption portion 70A. The damper chamber DA is positioned in the Z2 direction of the communication flow path 47A and communicates with the pressure chamber CC downstream of the communication flow path 47A. The damper chamber DA is positioned in the X1 direction when viewed from the pressure chamber CC. The nozzle N communicates with each of the plurality of the pressure chambers CC. The nozzle N is an opening that penetrates the communication plate 24 and the nozzle substrate 21 at the same position toward the Z1 direction of the pressure chamber CC. The position of the nozzle N in the X axis direction is the substantial center of the pressurization portion 70C.

A plurality of the nozzles N are formed in the nozzle substrate 21. The plurality of the nozzles N form a nozzle row N1. The nozzle row N1 includes a plurality of the nozzles N arranged in the Y axis direction. The nozzle N is a through-hole that penetrates the nozzle substrate 21 in the Z axis direction.

As illustrated in FIGS. 3 and 4, a plurality of the communication flow paths 47C are provided for each of the plurality of the pressure chambers CC. That is, the communication flow path 47C is an individual flow path individually coupled to the plurality of the pressure chambers CC. The plurality of the communication flow paths 47C communicate with downstream the pressure chamber CC. As illustrated in FIG. 2, an end portion in the X2 direction, which is the end portion downstream the pressure chamber CC, and an end portion in the X1 direction, which is the end portion upstream the communication flow path 47C, overlap each other when viewed in the Z axis direction. The communication flow path 47B is disposed downstream each of the plurality of the communication flow paths 47C. The end portions of the plurality of the communication flow paths 47C on the side opposite to the pressure chamber CC communicate with the communication flow path 47B as they are.

Each of the plurality of the vibration detection chambers DB is provided corresponding to the plurality of the pressure chambers CC. The vibration detection chamber DB is positioned in the Z2 direction of the communication flow path 47B. Each of the plurality of the vibration detection chambers DB communicates with the plurality of the communication flow paths 47B. The vibration detection chamber DB communicates with the pressure chamber CC via the communication flow paths 47B and 47C. The vibration detection chamber DB is provided in order to detect a residual vibration generated in the liquid when the liquid is ejected from the nozzle N by pressurizing the liquid in the pressurization portion 70C by the pressurization portion 70C.

The common liquid chamber RB is commonly provided for the plurality of the pressure chambers CC downstream the plurality of the pressure chambers CC via the communication flow path 47C and the communication flow path 47B. The common liquid chamber RB communicates in common with the plurality of the communication flow paths 47B. The common liquid chamber RB communicates with the pressure chamber CC via the communication flow paths 47B and 47C. The common liquid chamber RB is disposed downstream of the plurality of the pressure chambers CC.

The common liquid chamber RB is continuous in the Y axis direction. The common liquid chamber RB includes the flow path 43B provided in the case 28, the flow path 44B provided in the sealing plate 27, the flow path 45B provided in the pressure chamber substrate 25, and the flow path 46B provided in the communication plate 24. The flow paths 43B, 44B, 45B, and 46B are continuous in the Z axis direction.

In the present embodiment, as described above, the liquid ejecting head 10 adopts a circulation method in which the ink flowing through the pressure chamber CC is circulated. The liquid ejecting head 10 is coupled to a circulation mechanism 18 for circulating ink. The circulation mechanism 18 is provided with a pump, and supplies ink from a liquid container to the liquid ejecting head 10 by the operation of the pump. The ink passes through the supply port 42A of the liquid ejecting head 10 and is supplied to the common liquid chamber RA. In addition, the ink discharged from the liquid ejecting head 10 is recovered through the discharge port 42B from the common liquid chamber RB.

The ink in a liquid container 2 is transferred by the pump 83, flows in a supply flow path 81, passes through the supply port 42A illustrated in FIG. 2, and flows into the common liquid chamber RA. The ink in the common liquid chamber RA passes through the communication flow path 47A and the damper chamber DA, and is supplied to the pressure chamber CC. A part of the ink in the pressure chamber CC is ejected from the nozzle N.

The ink not ejected from the nozzle N passes through the communication flow path 47C and the communication flow path 47B and flows into the common liquid chamber RB. A part of the ink flowing through the communication flow path 47C flows into the vibration detection chamber DB. The ink in the common liquid chamber RB flows into a recovery flow path 82 through the discharge port 42B and is recovered by the circulation mechanism 18. In the liquid ejecting head 10 of the present embodiment, the ink is circulated in this manner.

As illustrated in FIGS. 2 and 3, the communication plate 24 is formed with the flow path 46A which is a part of the common liquid chamber RA, the communication flow path 47A, the communication flow path 47C, the communication flow path 47B, and the flow path 46B which is a part of the common liquid chamber RB. That is, the communication plate 24 is provided with a part of a supply flow path and a discharge flow path. The communication plate 24 is formed with a through-hole, a groove, a recessed portion, or the like. A part of the common liquid chambers RA and RB, and the communication flow paths 47A, 47B, and 47C are formed by these through-hole, the groove, the recessed portion, and the like. In the illustrated embodiment, the damper chamber DA and the communication flow path 47A are used as a common flow path corresponding to each of the pressure chambers CC, but at least one of the components can be formed as an individual flow path. In addition, when the common flow path is used, a configuration can be used in which the damper chamber DA and the communication flow path 47A are used as the common flow path associated with each of the plurality of the pressure chambers CC. The size (volume) of a vibrating region of the vibration absorption portion 70A changes depending on whether the form of the flow path of the damper chamber DA and the communication flow path 47A is an individual flow path or a common flow path. Therefore, the forms of the damper chamber DA and the communication flow path 47A, that is, whether these components have individual flow paths or a common flow path, may be set according to the absorption efficiency required for the liquid ejecting head 10. When at least a part of the component is used as the individual flow path, the third piezoelectric element 73 of the vibration absorption portion 70A may be individually provided corresponding to the individual flow path.

As illustrated in FIGS. 2 and 4, the pressure chamber substrate 25 is formed with the flow path 45A which is a part of the common liquid chamber RA, one damper chamber DA, the plurality of the pressure chambers CC, the plurality of the vibration detection chambers DB, and the flow path 45B which is a part of the common liquid chamber RA. In FIG. 4, the position of the arrangement of the nozzles N is indicated by a broken line so that the positional relationship between the nozzle N and the pressure chamber CC is clearly understood. The pressure chamber substrate 25 can be manufactured from, for example, a single crystal substrate of silicon. The pressure chamber substrate 25 may be manufactured from other materials.

As illustrated in FIG. 4, the damper chamber DA extends in the X axis direction, and the damper chamber DA and the common liquid chamber RA are separated from each other in the X axis direction. The damper chamber DA and the pressure chamber CC are formed as a common space that is continuous in the X axis direction. The damper chamber DA penetrates the pressure chamber substrate 25 in the Z axis direction. The damper chamber DA has a predetermined volume. The damper chamber DA has a shape that is continuous in the Y axis direction. A relay flow path may be formed between the damper chamber DA and the pressure chamber CC.

The pressure chamber CC extends in the X axis direction. The pressure chamber CC penetrates the pressure chamber substrate 25 in the Z axis direction. The pressure chamber CC has a predetermined volume. The plurality of the pressure chambers CC are disposed at predetermined intervals in the Y axis direction. The plurality of the pressure chambers CC communicate with a common damper chamber DA in the Y axis direction. The plurality of the pressure chambers CC constitute a pressure chamber row CL arranged in the Y axis direction. The pressure chamber row CL includes the plurality of the pressure chambers CC. In FIG. 4, imaginary lines L1 and L2 indicating the boundary of the pressure chamber CC are indicated by two-dot chain lines. The imaginary line L1 indicates an end of the pressure chamber CC in the X1 direction. The imaginary line L2 indicates an end of the pressure chamber CC in the X2 direction.

The plurality of the vibration detection chambers DB extend in the X axis direction. The vibration detection chamber DB and the pressure chamber CC are separated from each other in the X axis direction. As illustrated in FIG. 2, the communication flow path 47C is formed between the vibration detection chamber DB and the pressure chamber CC. The vibration detection chamber DB and the common liquid chamber RB are separated from each other in the X axis direction. The vibration detection chamber DB is formed to overlap the communication flow path 47B when viewed in the Z axis direction. The vibration detection chamber DB penetrates the pressure chamber substrate 25 in the Z axis direction. The vibration detection chamber DB and the communication flow path 47B communicate with each other in the Z axis direction. The vibration detection chamber DB has a predetermined volume. The plurality of the vibration detection chambers DB are disposed at predetermined intervals in the Y axis direction.

As described above, the liquid ejecting head 10 is provided with the vibration absorption portion 70A, the pressurization portion 70C, and the vibration detection portion 70B in this order from upstream the ink supply, and the wiring introduction portion RC is provided between the pressurization portion 70C and the vibration detection portion 70B. As illustrated in FIG. 1, the wiring introduction portion RC is formed from an opening portion 27a of the sealing plate 27 that is continuous to an opening portion of the case 28, and the COF 60 is introduced here. The wiring from the COF 60 and the COF 60 will be described later.

### A3 Configuration and Function of Vibration Absorption Portion 70A, Pressurization Portion 70C, and Vibration Detection Portion 70B

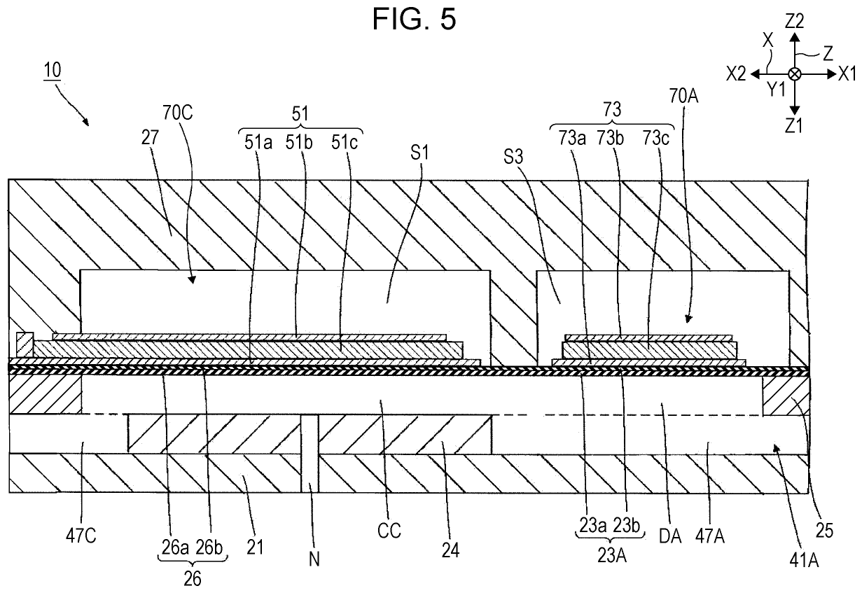

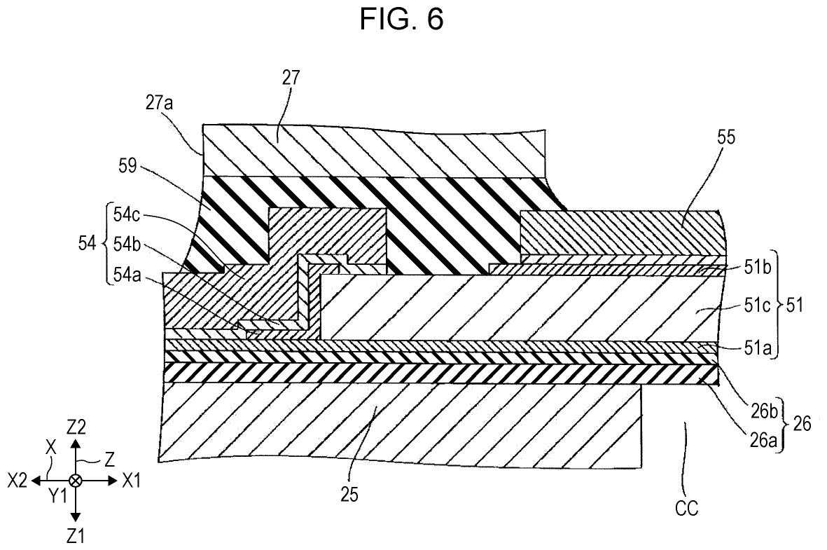

Next, the configurations of the vibration absorption portion 70A, the pressurization portion 70C, and the vibration detection portion 70B will be described with reference to FIGS. 5 to 7, focusing on the piezoelectric elements of each part. FIG. 6 is an enlarged cross-sectional view illustrating a part of the first vibration plate 26, the first piezoelectric element 51, and a first wiring portion 54 in the pressurization portion 70C illustrated in FIG. 5. As illustrated in FIGS. 5 to 7, the first piezoelectric element 51, the second piezoelectric element 72, and the third piezoelectric element 73 all are provided with electrodes on the upper surface (end surface in the Z2 direction) and the lower surface (end surface in the Z1 direction) of the piezoelectric body. When a voltage is applied between the upper and lower electrodes, the piezoelectric body interposed between the two electrodes is deformed by an electrostriction effect, and on the other hand, when force that deforms the piezoelectric body from the outside is applied, a voltage is generated between the electrodes by a piezoelectric effect. In the present embodiment, the first piezoelectric element 51, the second piezoelectric element 72, and the third piezoelectric element 73 have the same general configuration, but the first piezoelectric element 51 is used as a piezoelectric element that generates vibration by applying a voltage between electrodes to the first vibration plate 26, and the second piezoelectric element 72 is used as a piezoelectric element that generates pressure by applying vibration applied from the outside to the second vibration plate 29, and thereby detects vibration. The configuration of the third piezoelectric element 73 is the same as that of the other piezoelectric elements, but the upper and lower electrodes are not electrically coupled to each other, and the third piezoelectric element 73 is used as a mass for absorbing the pressure change of the liquid in the damper chamber DA.

Since the first piezoelectric element 51, the second piezoelectric element 72, and the third piezoelectric element 73 have the same configuration, first, the first piezoelectric element 51 is described as an example to describe the general configuration. The first piezoelectric element 51 includes a first lower electrode 51a, a first upper electrode 51b, and a first piezoelectric body 51c, and further includes a first vibration plate 26 on a lower portion of the first lower electrode 51a in the Z1 direction. The first lower electrode 51a, the first piezoelectric body 51c, and the first upper electrode 51b are laminated in this order on the first vibration plate 26. The first piezoelectric body 51c is interposed between the first lower electrode 51a and the first upper electrode 51b. Here, the first lower electrode 51a is an individual electrode that individually applies a potential to the plurality of the first piezoelectric elements 51, and the first upper electrode 51b is a common electrode that commonly applies a potential to the plurality of the first piezoelectric elements 51. However, the first lower electrode 51a may be a common electrode, and the first upper electrode 51b may be an individual electrode. The same applies to the second piezoelectric element 72 and the third piezoelectric element 73, which will be described later in order.

The first vibration plate 26 includes a first elastic layer 26a and a first insulating layer 26b. For example, the first elastic layer 26a is made of silicon dioxide (SiO₂). For example, the first insulating layer 26b is made of zirconium dioxide (Zro₂).

The plurality of the first piezoelectric elements 51 are formed above the first vibration plate 26 provided on the lower portion of the first lower electrode 51a in the Z1 direction. The first piezoelectric element 51 is disposed at a position overlapping the pressure chamber CC when viewed in the Z axis direction. The first piezoelectric element 51 is provided for each of the plurality of the pressure chambers CC.

The first vibration plate 26 is driven by the first piezoelectric element 51 and vibrates in the Z axis direction. The first vibration plate 26 that forms the upper wall surface of the pressure chamber CC is driven by the first piezoelectric element 51 on the pressure chamber CC. A specific configuration, material, and thickness of the first vibration plate 26, and a difference from the second vibration plate 29 will be described in detail in the sections of each embodiments described later, but as an example, a sum of the thicknesses of the first vibration plates 26 is, for example, 2 μm or less. The sum of the thicknesses of the first vibration plates 26 may be 15 μm or less, 40 μm or less, or 100 μm or less. For example, when the sum of the thicknesses of the first vibration plates 26 is 15 μm or less, a resin layer may be included. The first vibration plate 26 may be made of metal. Examples of the metal include stainless steel and nickel. When the first vibration plate 26 is made of metal, the thickness of the first vibration plate 26 may be 15 μm or more or 100 μm or less.

Hereinafter, the configuration of the first piezoelectric element 51 will be described in detail. The first lower electrode 51a provided on the upper surface of the first piezoelectric element 51 in the Z2 direction has an elongated shape along the X axis direction. The plurality of the first lower electrodes 51a are arranged at intervals from each other in the Y axis direction. The plurality of the first lower electrodes 51a are disposed for each of the plurality of the pressure chambers CC. Each of the first lower electrodes 51a is disposed at a position overlapping the plurality of the pressure chambers CC when viewed in the Z axis direction. The first upper electrode 51b has a band shape and extends in the Y axis direction. The first upper electrode 51b is continuous so as to cover the plurality of the first lower electrodes 51a.

The first lower electrode 51a includes a base layer and an electrode layer. For example, the base layer includes titanium (Ti). The electrode layer includes a low resistance conductive material such as platinum (Pt) or iridium (Ir). The electrode layer may be formed of an oxide such as strontium ruthenate (SrRuO₃) and lanthanum nickelate (LaNiO₂). The first piezoelectric body 51c is formed of a known piezoelectric material such as lead zirconate titanate (Pb(Zr, Ti)O₃) or ceramic.

The first upper electrode 51b includes a base layer and an electrode layer. For example, the base layer includes titanium. The electrode layer includes a low resistance conductive material such as platinum or iridium. The electrode layer may be formed of an oxide such as strontium ruthenate and lanthanum nickelate. In the first piezoelectric body 51c, a region between the first lower electrode 51a and the first upper electrode 51b is a drive region. The drive region is formed above each of the plurality of the pressure chambers CC.

A predetermined reference voltage is applied to the first upper electrode 51b. The reference voltage is a constant voltage, and is, for example, set to a voltage higher than a ground voltage. For example, a holding signal having a constant voltage is applied to the first upper electrode 51b. A drive signal having a variable voltage is applied to the first lower electrode 51a. A voltage corresponding to a difference between the reference voltage applied to the first upper electrode 51b and the drive signal supplied to the first lower electrode 51a is applied to the first piezoelectric body 51c. The drive signal corresponds to the ejecting amount of the liquid ejected from the nozzle N.

When a voltage is applied between the first lower electrode 51a and the first upper electrode 51b, the first piezoelectric body 51c is deformed, and thus the first piezoelectric element 51 generates energy that causes the first vibration plate 26 to bend and deform. When the first vibration plate 26 vibrates by the energy generated by the first piezoelectric element 51, the pressure of the liquid in the pressure chamber CC changes and the liquid in the pressure chamber CC is ejected from the nozzle N.

As illustrated in FIG. 6, which is an enlarged view of the lead wiring portion which is a coupling portion between the pressurization portion 70C and the first wiring portion 54, the first wiring portion 54 is coupled to the end portion of the first piezoelectric element 51 in the Y direction. The first wiring portion 54 has an electrode layer 54a, a first adhesion layer 54b, and a first wiring layer 54c. The electrode layer 54a covers the end surface of the first piezoelectric body 51c in the X2 direction. The end surface in the X2 direction has a surface intersecting the X axis direction. The first adhesion layer 54b covers the electrode layer 54a and the first lower electrode 51a. The first adhesion layer 54b is in close contact with the electrode layer 54a and the first lower electrode 51a. The first wiring layer 54c covers the first adhesion layer 54b. The first wiring layer 54c is electrically coupled to the first lower electrode 51a via the first adhesion layer 54b.

The first piezoelectric element 51 is provided with a VBS wiring 55. The VBS wiring 55 is disposed on the first upper electrode 51b and extends in the Y axis direction. The VBS wiring has a band shape when viewed from the Z axis direction, and is formed so as to cover the first upper electrode 51b. The VBS wiring 55 couples the first upper electrode 51b of the first piezoelectric element 51 and a flexible wiring substrate 61. The first upper electrode 51b and the flexible wiring substrate 61 are electrically coupled to each other, which will be described later. The VBS wiring 55 is electrically coupled to the COF 60 at the end portion of the liquid ejecting head 10 in the Y axis direction. The VBS wiring 55 is provided as an auxiliary wiring that substantially reduces the electric resistance of the first upper electrode 51.

An insulating adhesive layer 59 is formed between the first piezoelectric element 51 and the sealing plate 27 by an insulating adhesive. The insulating adhesive layer 59 bonds the first piezoelectric element 51 to the sealing plate 27 and insulates the end surface of the first wiring layer 54c and the end surface of the VBS wiring 55. The latter prevents electrical conduction that may occur due to ion migration.

In the first wiring portion 54 of the liquid ejecting head 10, each of the plurality of the first wiring portions 54 is coupled to the plurality of the first lower electrodes 51a. The plurality of the first wiring portions 54 extend in the X axis direction and are drawn out into the opening portion 27a of the wiring introduction portion RC. The opening portion 27a penetrates the sealing plate 27 in the Z axis direction. When viewed in the Z axis direction, the first wiring portion 54 is electrically coupled to the COF 60 at a position corresponding to the opening portion 27a. The first wiring portion 54 is formed of a conductive material having a lower resistance than the first lower electrode 51a. For example, the first wiring portion 54 is a conductive pattern having a structure in which a conductive film of gold (Au) is laminated on a surface of a conductive film formed of nichrome (NiCr).

Next, the vibration absorption portion 70A will be briefly described. The vibration absorption portion 70A on the supply side is provided for the damper chamber DA on the supply side. As illustrated in FIG. 5, the vibration absorption portion 70A is provided with the third piezoelectric element 73. The third piezoelectric element 73 is provided with a third vibration plate (hereinafter, also referred to as a compliance substrate) 23. The compliance substrate 23 is positioned in the X1 direction of the first vibration plate 26. The compliance substrate 23 is disposed on the upper surface of the pressure chamber substrate 25. The compliance substrate 23 covers a part of the opening of the pressure chamber substrate 25 corresponding to the damper chamber DA. The compliance substrate 23 constitutes an upper wall surface of the damper chamber DA. The compliance substrate 23 is disposed at a position corresponding to the sealing space S3 formed in the sealing plate 27 when viewed in the Z axis direction.

The compliance substrate 23 includes a flexible film. The compliance substrate 23 includes a third elastic layer 23a and a third insulating layer 23b. For example, the third elastic layer 23a is made of silicon dioxide (SiO₂). For example, the third insulating layer 23b is made of zirconium dioxide (ZrO₂). The third elastic layer 23a is formed above the pressure chamber substrate 25, and the third insulating layer 23b is formed above the third elastic layer 23a. The third elastic layer 23a is continuously formed with the first elastic layer 26a of the first vibration plate 26 that covers the pressure chamber CC. The third insulating layer 23b is continuously formed with the first insulating layer 26b of the first vibration plate 26. The compliance substrate 23 can be deformed by receiving the pressure of the ink. The compliance substrate 23 is deformed by the pressure of the ink and absorbs the pressure fluctuation of the ink in the damper chamber DA. A plurality of the compliance substrates 23 individually change corresponding to the damper chamber DA.

As illustrated in FIG. 5, the vibration absorption portion 70A is provided with the third piezoelectric element 73. The third piezoelectric element 73 is disposed at a position overlapping the damper chamber DA when viewed in the Z axis direction. The third piezoelectric element 73 is provided for the damper chamber DA. The third piezoelectric element 73 has a third lower electrode 73a, a third upper electrode 73b, a third piezoelectric body 73c, and a compliance substrate 23, similar to the first piezoelectric element 51. The third lower electrode 73a, the third upper electrode 73b, and the third piezoelectric body 73c are laminated in this order on the compliance substrate 23. The third piezoelectric body 73c is interposed between the third lower electrode 73a and the third upper electrode 73b, and the disposition, structure, material, and the like of the electrodes are the same as those of the first piezoelectric element 51, and thus detailed description thereof will be omitted.

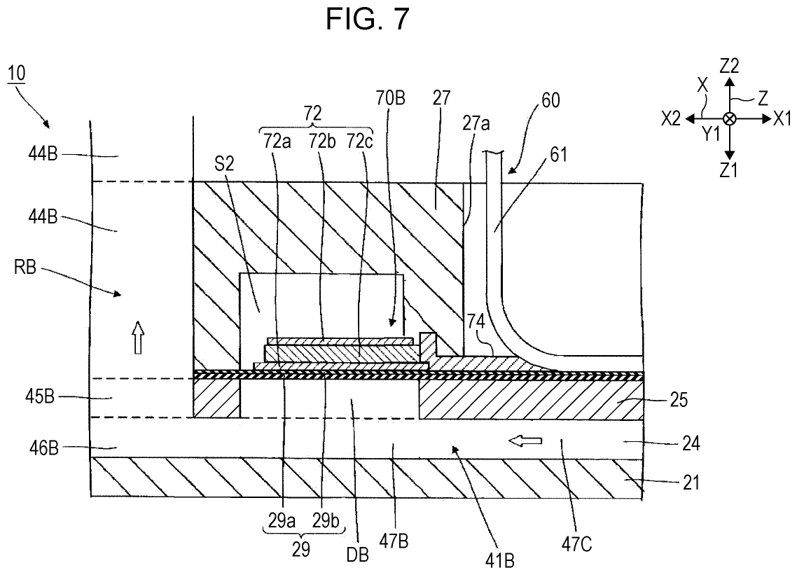

Finally, the configuration of the vibration detection portion 70B will be described with reference to FIG. 7. As illustrated in the drawing, the vibration detection portion 70B is provided with a second piezoelectric element 72. The second piezoelectric element 72 is provided with a second vibration plate 29. The second vibration plate 29 is positioned in the X2 direction of the first vibration plate 26. The second vibration plate 29 is positioned on a side opposite to the compliance substrate 23 with respect to the first vibration plate 26 in the X axis direction. As illustrated in the drawing, the second vibration plate 29 is disposed on the upper surface of the pressure chamber substrate 25. The second vibration plate 29 covers a part of the opening of the pressure chamber substrate 25 corresponding to the vibration detection chamber DB. The second vibration plate 29 constitutes an upper wall surface of the vibration detection chamber DB. The second vibration plate 29 is disposed at a position corresponding to the sealing space S2 formed in the sealing plate 27 when viewed in the Z axis direction.

The second vibration plate 29 includes a flexible film. The second vibration plate 29 includes a second elastic layer 29a and a second insulating layer 29b. For example, the second elastic layer 29a is made of silicon dioxide (SiO₂). For example, the second insulating layer 29b is made of zirconium dioxide (ZrO₂). The second elastic layer 29a is formed above the pressure chamber substrate 25, and the second insulating layer 29b is formed above the second elastic layer 29a. The second elastic layer 29a may be formed continuously with the first elastic layer 26a of the first vibration plate 26, or may be formed separately. The second insulating layer 29b may be continuously formed with the first insulating layer 26b of the first vibration plate 26, or may be formed separately.

Each of the plurality of the second vibration plates 29 is provided for the plurality of the vibration detection chambers DB arranged in the Y axis direction. The second vibration plate 29 can be deformed by receiving the pressure of the ink. The second vibration plate 29 is deformed in response to the pressure fluctuation of the ink in the vibration detection chamber DB. The plurality of the second vibration plates 29 individually change corresponding to the plurality of the vibration detection chambers DB. The plurality of the second piezoelectric elements 72 are formed above the second vibration plate 29. The second piezoelectric element 72 is disposed at a position overlapping the vibration detection chamber DB when viewed in the Z axis direction. The second piezoelectric element 72 is provided for each of the plurality of the vibration detection chambers DB.

The second piezoelectric element 72 has a second lower electrode 72a, a second upper electrode 72b, a second piezoelectric body 72c, and a second vibration plate 29, similar to the first piezoelectric element 51. The second lower electrode 72a, the second upper electrode 72b, and the second piezoelectric body 72c are laminated in this order on the second vibration plate 29. The second piezoelectric body 72c is interposed between the second lower electrode 72a and the second upper electrode 72b. The second lower electrode 72a has an elongated shape along the X axis direction. The plurality of the second lower electrodes 72a are arranged at intervals from each other in the Y axis direction. The plurality of the second lower electrodes 72a are disposed for each of the plurality of the vibration detection chambers DB. Each of the second lower electrode 72a is disposed at a position overlapping the plurality of the vibration detection chambers DB when viewed in the Z axis direction. The second upper electrode 72b has a band shape and extends in the Y axis direction. The second upper electrode 72b continuously covers the plurality of the second lower electrodes 72a.

The structure and the material of the second lower electrode 72a are the same as those of the first lower electrode 51a of the first piezoelectric element 51. The structure and the material of the second upper electrode 72b are the same as those of the first upper electrode 51b of the first piezoelectric element 51. The structure and the material of the second piezoelectric body 72c are the same as those of the first piezoelectric body 51c of the first piezoelectric element 51. The second piezoelectric element 72 can be formed in the same manner as the first piezoelectric element 51 and the third piezoelectric element 73. In addition, although a detailed illustration is omitted, the second lower electrode 72a and the second upper electrode 72b of the second piezoelectric element 72 are coupled to the flexible wiring substrate 61, similar to the first lower electrode 51a and the first upper electrode 51b of the first piezoelectric element 51. In the drawing, the wiring from the flexible wiring substrate 61 to the second piezoelectric element 72 is illustrated as a second wiring portion 74. The configuration of a coupling portion between the second piezoelectric element 72 and the second wiring portion 74 is the same as the configuration using the electrode layer 54a, the first adhesion layer 54b, and the first wiring layer 54c of the first wiring portion 54 in the first piezoelectric element 51 illustrated in FIG. 6, and thus the illustration and description thereof will be omitted.

The drive signal output to the first piezoelectric element 51 of the pressurization portion 70C, the detection signal detected by the second piezoelectric element 72 of the vibration detection portion 70B, and the like are exchanged with a control circuit 62 via the flexible wiring substrate 61. The flexible wiring substrate 61 is a flexible wiring substrate. For example, the flexible wiring substrate 61 is an FPC. For example, the flexible wiring substrate 61 may be an FFC. FPC is an abbreviation for Flexible Printed Circuit. FFC is an abbreviation for Flexible Flat Cable.

As illustrated in FIG. 6, the flexible wiring substrate 61 is electrically coupled to the first lower electrode 51a or the first upper electrode 51b of the first piezoelectric element 51 of the pressurization portion 70C and the second lower electrode 72a or the second upper electrode 72b of the vibration detection portion 70B via a first wiring portion 54 (to be described later). The flexible wiring substrate 61 is electrically coupled to a control portion 20 and exchanges a signal for driving the first piezoelectric element 51 of the pressurization portion 70C, a detection signal corresponding to a residual vibration generated in the second piezoelectric element 72 of the vibration detection portion 70B, and the like with the control portion 20 via the control circuit 62.

The control circuit 62 is mounted on the flexible wiring substrate 61. The control circuit 62 includes a switching element for driving the first piezoelectric element 51. The control circuit 62 receives a drive signal Com for the first piezoelectric element 51 output from the control portion 20. The switching element of the control circuit 62 switches whether or not to supply the drive signal Com to the first piezoelectric element 51. The control circuit 62 supplies a drive voltage or current to the first piezoelectric element 51 to vibrate the first vibration plate 26. In addition, the control circuit 62 receives the voltage signal generated in the second piezoelectric element 72 by the vibration of the second vibration plate 29 generated by the residual vibration in the ink, extracts information such as the magnitude and the frequency of the residual vibration, and outputs the information to the control portion 20.

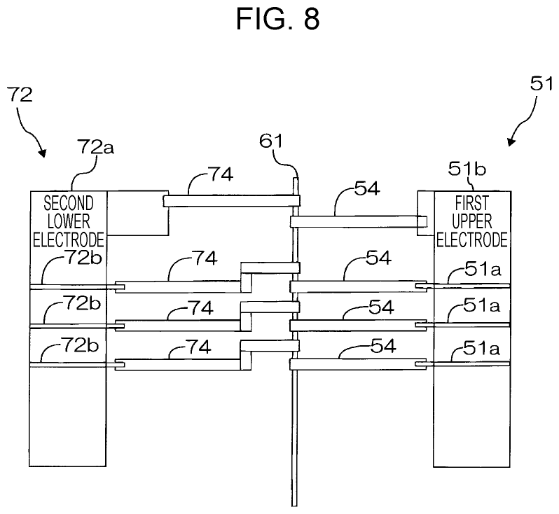

The wiring from the flexible wiring substrate 61 to the first piezoelectric element 51 and the second piezoelectric element 72 is schematically illustrated in FIG. 8. In the drawing, the flexible wiring substrate 61 does not indicate one wiring, and indicates a set of a plurality of the wirings. The drive signal output from the control circuit 62 to the first piezoelectric element 51 via the flexible wiring substrate 61 is transmitted to the first upper electrode 51b and the first lower electrode 51a via the first wiring portion 54. In addition, the detection signal from the second piezoelectric element 72 is transmitted to the second upper electrode 72b and the second lower electrode 72a via the second wiring portion 74 to the second piezoelectric element 72.

### A4 Configuration as First Embodiment

Hereinbefore, the basic configuration of the liquid ejecting head 10 is described. Based on the above basic configuration, the pressurization portion 70C and the vibration detection portion 70B of each embodiment have a unique configuration as described below. The unique configuration will be described in order.

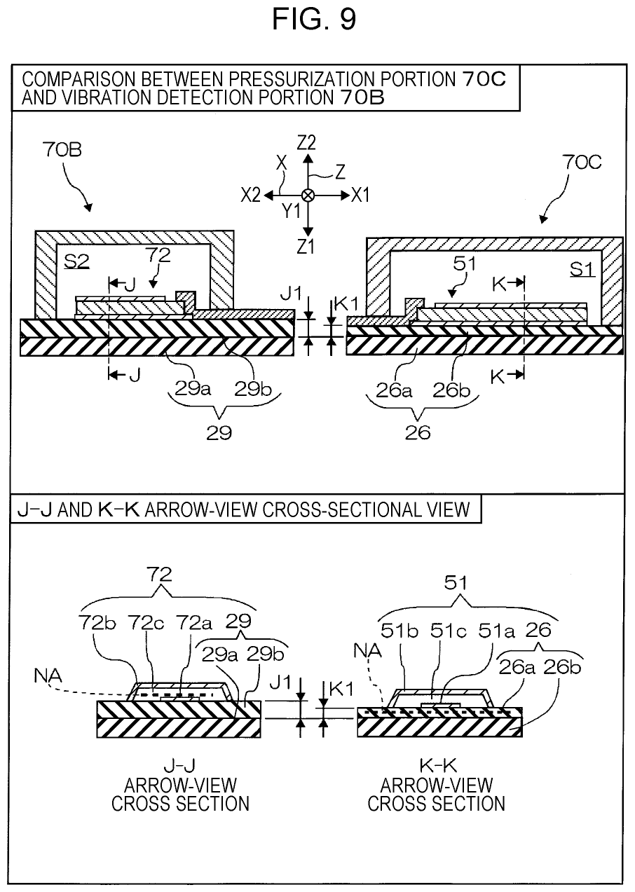

FIG. 9 is an explanatory diagram illustrating a comparison of a form of the first piezoelectric element 51 in the pressurization portion 70C and a form of the second piezoelectric element 72 in the vibration detection portion 70B according to the first embodiment. An upper part of the figure schematically illustrates a shape of a cross section of both on the X-Z planes when viewed in the Y direction, and a lower part of the figure schematically illustrates a J-J arrow-view cross section and a K-K arrow-view cross section of the upper part of the figure. For convenience of illustration, the first vibration plate 26 and the second vibration plate 29 are given reference numerals separately from the first piezoelectric element 51 and the second piezoelectric element 72, but as already described, the first vibration plate 26 is included in the first piezoelectric element 51, and the second vibration plate 29 is included in the second piezoelectric element 72. In the drawings of other embodiments, both may be given separate reference numerals for convenience of illustration.

As illustrated in comparison with the first piezoelectric element 51 and the second piezoelectric element 72 of the first embodiment, when the first vibration plate 26 of the first piezoelectric element 51 of the pressurization portion 70C and the second vibration plate 29 of the second piezoelectric element 72 of the vibration detection portion 70B are compared, the thickness K1 of the first insulating layer 26b constituting the first vibration plate 26 is thinner than the thickness J1 of the second insulating layer 29b constituting the second vibration plate 29. In the first piezoelectric element 51 and the second piezoelectric element 72, at least the dimensions in each part in the X direction are substantially the same except for the thicknesses of the first insulating layers 26b and 29b. As a result, the position of the neutral axis of the first piezoelectric element 51 of the pressurization portion 70° C. in the Z direction (also referred to as a first height) and the position of the neutral axis of the second piezoelectric element 72 of the vibration detection portion 70B in the Z direction (also referred to as a second height) are different from each other.

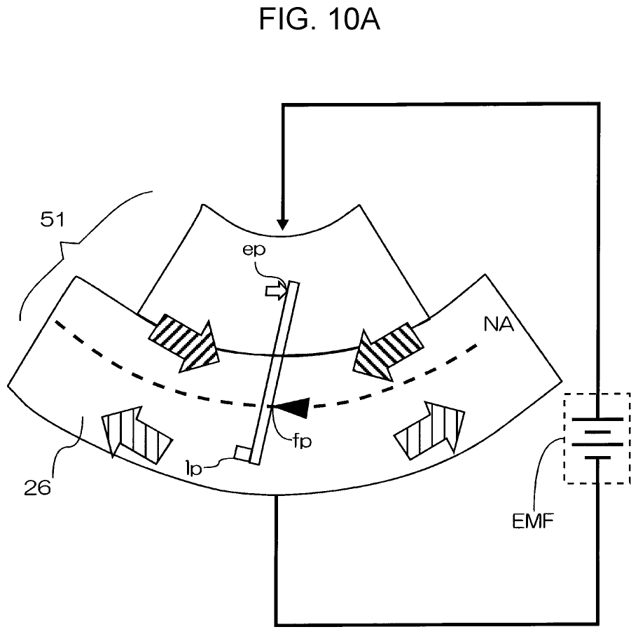

The neutral axis in the piezoelectric element refers to a position where tensile force and compressive force are balanced in a cross section when the piezoelectric body is deformed and a bending moment is generated in the member. The position where the tensile force and the compressive force symmetrically generated by the deformation of the piezoelectric body are balanced is a so-called fulcrum of the deformation, and the force generated by the deformation is applied to one side (force point) with the fulcrum interposed therebetween, and the force acts on the other side (action point) with the fulcrum interposed therebetween. FIG. 10A schematically illustrates a case of the pressurization portion 70C. In this case, the first piezoelectric element 51 is bonded to the substantial center of the first vibration plate 26 in the X direction, the first piezoelectric body 51c and the first insulating layer 26b of the bonded first piezoelectric element 51 have tensile stress, and the first elastic layer 26a has compressive stress. Since the first elastic layer 26a has the compressive stress (stress against compression), the first elastic layer 26a tends to extend as a film alone, and this becomes force toward the outside as illustrated by the arrow on the lower side in FIGS. 10A and 10B. On the other hand, since the piezoelectric body and the insulating layer have the tensile stress (stress against tensile stress), the piezoelectric body and the insulating layer tend to shrink as a film. This is force inward as illustrated by the arrow on the upper side in FIGS. 10A and 10B. The position where this force, that is, the compressive stress and the tensile stress, are balanced corresponds to the position of a neutral axis NA. In this state, when a voltage is applied between the first lower electrode 51a and the first upper electrode 51b of the first piezoelectric element 51, the force of deformation generated in the first piezoelectric body 51c acts on the first insulating layer 26b with a neutral axis NS as a fulcrum. The same applies to a relationship between the compressive stress and the tensile stress in an initial state in the vibration detection portion 70B described below and a case where force is applied to the piezoelectric body by the force applied from the outside.

When a predetermined voltage is applied between the first lower electrode 51a and the first upper electrode 51b of the first piezoelectric element 51 by the power supply EMF, the first piezoelectric body 51c is deformed. At this time, as illustrated in FIG. 10A, a force point ep to which stress due to deformation of the first piezoelectric body 51c is applied is opposite to an action point lp on which stress that deforms the first elastic layer 26a of the first vibration plate 26 acts, with the position of the neutral axis NA as the fulcrum fp. According to the principle of leverage, force F1e applied to the force point ep is force F2e according to a ratio (Lee/Lle) of the distance Lee from the force point ep to the fulcrum fp to the distance Lle from the fulcrum fp to the action point lp, that is, F2e=(Lee/Lle)×F1e . . . (1), as illustrated in the following equation (1), and acts on the first elastic layer 26a at the action point lp.

As illustrated in the drawing, when Lee>Lle, the force F1e of the first piezoelectric element 51 can be amplified, so to speak, the first elastic layer 26a can be deformed, and strong force can be applied to the ink filled in the pressure chamber CC. That is, it is easy to secure the pressure required for ejecting the ink from the nozzle N in the pressurization portion 70C.

On the other hand, in the vibration detection portion 70B, the second piezoelectric element 72 is provided to detect the residual vibration applied to the second vibration plate 29. In the second piezoelectric element 72, as illustrated in FIG. 10B, when the residual vibration in the ink is applied to the second vibration plate 29 and the second piezoelectric body 72c is deformed, the potential of the second lower electrode 72a with respect to the second upper electrode 72b changes due to electromotive force generated by the piezoelectric effect. When the change in the potential is detected by a voltage detector MQ, the force applied to the second vibration plate 29, that is, the magnitude of the residual vibration can be detected. In the vibration detection portion 70B, as illustrated in comparison with FIG. 9, the thickness J1 of the second insulating layer 29b of the second vibration plate 29 to which the second piezoelectric element 72 is bonded is thicker than the thickness K1 of the corresponding first insulating layer 26b of the pressurization portion 70C. Therefore, as illustrated in FIG. 10B, the position (second position) of the neutral axis NA in the Z direction is higher than the position (first height) of the neutral axis NA in the Z direction of the first piezoelectric element 51 in the pressurization portion 70C.

As a result, although the positions of the force point and the action point in the vibration detection portion 70B are reversed from those of the pressurization portion 70C, the distance Lev from the force point lp, where the force due to the deformation of the second vibration plate 29 is applied, to the fulcrum fp, which is the position of the neutral axis NA, is relatively longer than the distance Llv from the fulcrum fp to the action point lp. That is, as illustrated in the following equation (2), force F2v obtained by multiplying force F1v received by the second vibration plate 29 due to the residual vibration by a ratio of the two distances (Lev/Llv), that is, F2v=(Lev/Llv)×F1v . . . (2) acts on the second piezoelectric element 72 at the action point lp.

As illustrated in the drawing, when Lev>Llv, the force applied to the second vibration plate 29 by the residual vibration can be amplified, so to speak, and the second piezoelectric element 72 can be deformed. Therefore, the electromotive force generated by the piezoelectric effect can be increased. Therefore, the residual vibration can be easily detected.

In FIGS. 10A and 10B, the position (first height and second height) of the neutral axis NA is illustrated as Lee>Lle and Lev>Llv due to the difference between the thickness K1 of the first insulating layer 26b and the thickness J1 of the second insulating layer 29b, but as long as the value of Lev/Llv in the vibration detection portion 70B is larger than the value of Lev/Llv when J1=K1 by setting J1>K1, it does not matter when Lev>Llv does not satisfied.

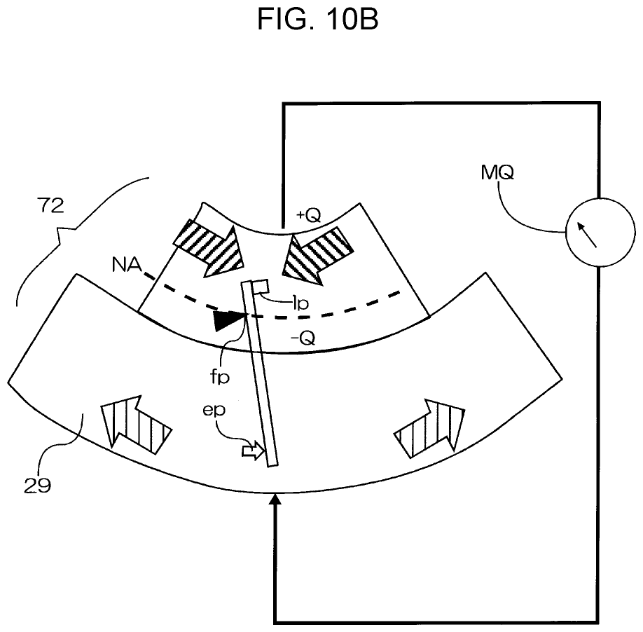

An example of a drive signal applied between the electrodes of the first piezoelectric element 51 of the pressurization portion 70C of the above embodiment and a residual vibration generated in ink when the ink is ejected in response to the drive signal is illustrated in FIG. 11. When the ink is to be ejected from the nozzle N, as illustrated in the upper part of the figure, a first drive signal VinA is applied between the electrodes of the first piezoelectric element 51 of an ejecting portion 70C. The first drive signal VinA is a signal having a waveform change for driving the meniscus of the nozzle N by a pull-push-pull method. The first piezoelectric element 51 is driven by the first drive signal VinA, and causes a pressure change in the pressure chamber CC to eject ink droplets from the nozzle N. The pressure fluctuation occurs in the ink in the pressure chamber CC due to the pull-push-pull drive. This pressure fluctuation remains for a predetermined period even after the ink droplet is ejected. This is called the residual vibration.

In the vibration detection portion 70B, the pressure fluctuation is detected by the second piezoelectric element 72. The pressure fluctuation generated in the pressure chamber CC propagates to the vibration detection chamber DB, and thus the second piezoelectric element 72 detects the pressure fluctuation and outputs the pressure fluctuation as a residual vibration signal Vout. Specifically, the second piezoelectric element 72 detects the pressure change of the ink as the residual vibration during a period Td from a point in time when the drive signal VinA returns to the predetermined potential V3, and outputs the residual vibration signal Vout. The control circuit 62 acquires a cycle NTc of the residual vibration, a phase time TF, and an amplitude Vmax from the residual vibration signal Vout A. Furthermore, the control portion 20 that acquires these pieces of information from the control circuit 62 detects an event such as nozzle clogging or ink thickening.

In the liquid ejecting head 10 of the first embodiment described above, the thickness J1 of the second insulating layer 29b of the second vibration plate 29 of the vibration detection portion 70B, to which the second piezoelectric element 72 is bonded, is thicker than the thickness K1 of the first insulating layer 26b of the first vibration plate 26 of the pressurization portion 70C, to which the first piezoelectric element 51 is bonded, while the first piezoelectric element 51 used in the vibration detection portion 70B and the second piezoelectric element 72 used in the pressurization portion 70C are configured to be substantially the same. In this manner, the position of the neutral axis NA in the vibration detection portion 70B can be made higher than the position of the neutral axis NA in the pressurization portion 70C in the Z direction, and the characteristics required for both the pressurization portion 70C and the vibration detection portion 70B can be satisfied. Specifically, in the pressurization portion 70C, the ink in the pressure chamber CC is pressurized by the force F2e obtained by increasing the force F1e by the first piezoelectric element 51 itself, and the ink can be reliably ejected from the nozzle N. In the vibration detection portion 70B, the second piezoelectric element 72 is deformed by the force F2v obtained by increasing the force F1v by the residual vibration of the ink in the vibration detection chamber DB, and thus the residual vibration can be accurately detected. Since the first piezoelectric element 51 used in the vibration detection portion 70B and the second piezoelectric element 72 used in the pressurization portion 70C can be configured to be substantially the same, the liquid ejecting head 10 can be easily manufactured. In addition, in this manner, the throughput of ink ejection in the liquid ejecting head 10 can be sufficiently increased.

### A5 Modification Example

In the first embodiment, the thicknesses of each part are the same except that the thicknesses of the first insulating layer 26b and the second insulating layer 29b are different. In this case, the height of the neutral axis NA can be obtained as the height from the lower surface (end surface in the Z1 direction) of the first vibration plate 26 or the second vibration plate 29. Therefore, it can be easily obtained that the neutral axis NA in the vibration detection portion 70B is positioned above the neutral axis in the pressurization portion 70C. When the thickness of each of the layers other than the thicknesses of the first insulating layer 26b and the second insulating layer 29b is different, the height of the neutral axis may be defined as follows, and the height of the neutral axis in the vibration detection portion 70B may be compared with the height of the neutral axis in the pressurization portion 70C.

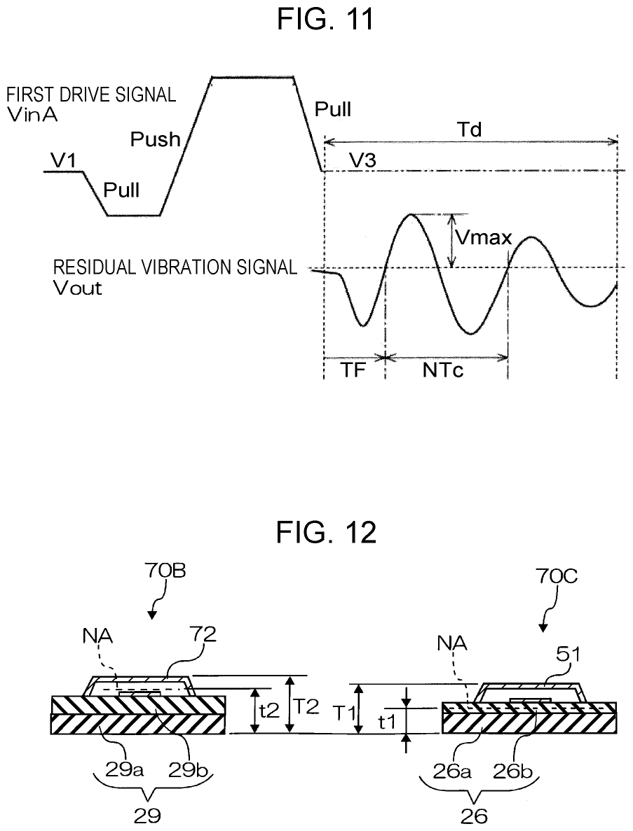

FIG. 12 is an explanatory diagram illustrating the definition of the height of the neutral axis NA. Here, the height of the neutral axis NA of the first piezoelectric element 51 in the pressurization portion 70C is defined as t1/T1. Here, T1 is a thickness (dimension in the Z direction) of the first piezoelectric element 51, and is specifically a distance from the upper surface of the first upper electrode 51b at the uppermost portion of the first piezoelectric element 51 to the lower surface of the first vibration plate 26. In addition, t1 is a distance from the lower surface of the first vibration plate 26 to the neutral axis NA. Similarly, for the second piezoelectric element 72 in the vibration detection portion 70B, the height of the neutral axis NA is defined as t2/T2. Here, T2 is the thickness (dimension in the Z direction) of the second piezoelectric element 72, and is specifically a distance from the upper surface of the second upper electrode 72b at the uppermost portion of the second piezoelectric element 72 to the lower surface of the second vibration plate 29. In addition, t2 is a distance from the lower surface of the second vibration plate 29 to the neutral axis NA.

In the first embodiment, the position of the neutral axis NA of the second piezoelectric element 72 is described as higher than the position of the neutral axis NA of the first piezoelectric element 51, that is, on the upper side by making the thickness of the first insulating layer 26b of the first vibration plate 26 and the thickness of the second insulating layer 29b of the second vibration plate 29 different from each other. However, in accordance with the above definition, this is equivalent to t2/T2>t1/T1 . . . (3) as illustrated in the above expression (3).

By defining in this manner, for example, even when there is a slight difference in thickness between the first elastic layer 26a and the second elastic layer 29a, the difference in height of the neutral axis NA can be determined.

### B. Second Embodiment

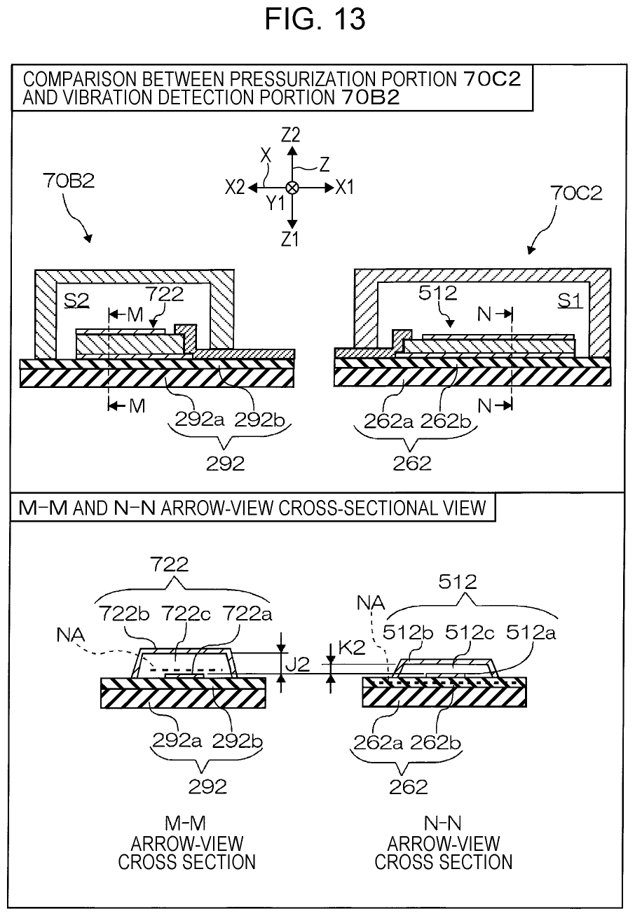

Next, a liquid ejecting head 10 of a second embodiment will be described. FIG. 13 is an explanatory diagram illustrating a comparison of a configuration of the vibration detection portion 70B2 and the pressurization portion 70C2 in the liquid ejecting head 10 according to the second embodiment. An upper part of the figure schematically illustrates a shape of a cross section of both on the X-Z planes when viewed in the Y direction, and a lower part of the figure schematically illustrates an M-M arrow-view cross section and an N-N arrow-view cross section of the upper part of the figure. As illustrated in the drawing, the pressurization portion 70C2 is provided with a first piezoelectric element 512. The first piezoelectric element 512 includes a first vibration plate 262 at the lowest portion thereof in the Z direction. The first vibration plate 262 is configured by laminating a first elastic layer 262a and a first insulating layer 262b, similar to the first embodiment. On the other hand, the vibration detection portion 70B2 is provided with a second piezoelectric element 722. The second piezoelectric element 722 includes a second vibration plate 292 at the lowest portion thereof in the Z direction. The second vibration plate 292 is configured by laminating a second elastic layer 292a and a second insulating layer 292b, similar to the first embodiment.

In the liquid ejecting head 10 of the second embodiment, the entire configuration is common to that of the first embodiment, but a method of making the height of the neutral axis NA of the second piezoelectric element 722 higher than the height of the neutral axis NA of the first piezoelectric element 512 is different. In the first embodiment, the height of the neutral axes of both is adjusted by making the thickness of the second insulating layer 29b and the first insulating layer 26b different from each other, but in the second embodiment, the thickness of the second insulating layer 292b of the second piezoelectric element 722 and the thickness of the first vibration plate 262 of the first piezoelectric element 512 are the same as each other, and the thickness of the second piezoelectric body 722c and the first piezoelectric body 512c are different from each other, so that the height of the neutral axes of both is adjusted.

As illustrated in the drawing, the first piezoelectric element 512 is provided with a first lower electrode 51a, a first upper electrode 512b, a first piezoelectric body 512c, and a first vibration plate 262. In the first vibration plate 262, the first elastic layer 262a and the first insulating layer 262b are bonded to each other. The material and the like of each part of the first piezoelectric element 512 are the same as those of the first embodiment. The second piezoelectric element 722 is provided with a second lower electrode 722a, a second upper electrode 722b, a second piezoelectric body 722c, and a second vibration plate 292. In the second vibration plate 292, the second elastic layer 292a and the second insulating layer 292b are bonded to each other. The material and the like of each part of the second piezoelectric element 722 are the same as those of the first embodiment.

In the second embodiment, a thickness J2 of the second piezoelectric body 722c is thicker than a thickness K2 of the first piezoelectric body 512c. All the thicknesses of the other layers are substantially the same. The thickness of each part in the second embodiment is defined such that the expression (3) described in the modification example of the first embodiment is satisfied. Since the thickness J2 of the second piezoelectric body 722c is thicker than the thickness K2 of the first piezoelectric body 512c, the neutral axis NA of the second piezoelectric element 722 is positioned higher than the neutral axis NA of the first piezoelectric element 512. As a result, similar to the first embodiment, in the pressurization portion 70C2, the first vibration plate 262 is easily vibrated by force generated by the first piezoelectric element 512, in the vibration detection portion 70B2, strong force is transmitted to the second piezoelectric element 722 by the residual vibration received by the second vibration plate 292 from the ink, and the electromotive force can be efficiently generated. Therefore, the request for sufficiently increasing the pressure of the ink in the pressure chamber CC and for accurately detecting the residual vibration of the ink in the vibration detection chamber DB can be simultaneously satisfied. As a result, the throughput of ink ejection in the liquid ejecting head 10 can be sufficiently increased.

### C. Third Embodiment

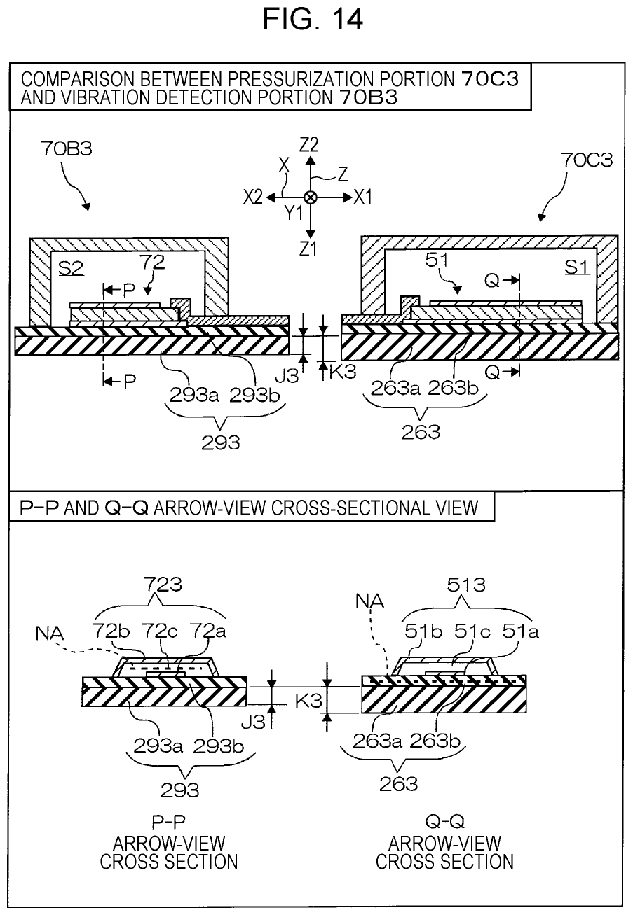

Next, a liquid ejecting head 10 of a third embodiment will be described. FIG. 14 is an explanatory diagram illustrating a comparison of a configuration of the vibration detection portion 70B3 and the pressurization portion 70C3 in the liquid ejecting head 10 according to the third embodiment. An upper part of the figure schematically illustrates a shape of a cross section of both on the X-Z planes when viewed in the Y direction, and a lower part of the figure schematically illustrates a P-P arrow-view cross section and a Q-Q arrow-view cross section of the upper part of the figure. As illustrated in the drawing, the pressurization portion 70C3 is provided with a first piezoelectric element 513. Since the configuration of the first piezoelectric element 513 is the same as that of the first embodiment including the thickness, a detailed description thereof will be omitted. The first piezoelectric element 513 includes a first vibration plate 263 at the lowest portion thereof in the Z direction. The first vibration plate 263 is configured by laminating a first elastic layer 263a and a first insulating layer 263b, similar to the first embodiment. On the other hand, the vibration detection portion 70B3 is provided with a second piezoelectric element 723. Since the configuration of the second piezoelectric element 723 is the same as that of the first embodiment including the thickness, a detailed description thereof will be omitted. The second piezoelectric element 723 includes a second vibration plate 293 at the lowest portion thereof in the Z direction. The second vibration plate 293 is configured by laminating a second elastic layer 293a and a second insulating layer 293b, similar to the first embodiment.

In the liquid ejecting head 10 of the third embodiment, the entire configuration is common to that of the first embodiment, but a method of making the height of the neutral axis NA of the second piezoelectric element 723 higher than the height of the neutral axis NA of the first piezoelectric element 513 is different. In the first embodiment, the height of the neutral axes of both is adjusted by making the thickness of the second insulating layer 29b and the first insulating layer 26b different from each other, but in the third embodiment, the thickness of the second insulating layer 293b of the second piezoelectric element 723 and the thickness of the first vibration plate 263 of the first piezoelectric element 513 are the same as each other, and the thickness of the second elastic layer 293a and the first elastic layer 263a are different from each other, so that the height of the neutral axes of both is adjusted.

In the first vibration plate 263 of the first piezoelectric element 513, the first insulating layer 263b and the first elastic layer 263a are bonded to each other. The material and the like of each part of the first piezoelectric element 513 are the same as those of the first embodiment. In the second vibration plate 293 of the second piezoelectric element 723, the second elastic layer 293a and the second insulating layer 293b are bonded to each other. The material and the like of each part of the second piezoelectric element 723 are the same as those of the first embodiment.

In the third embodiment, a thickness K3 of the first piezoelectric body 513c is thicker than a thickness J3 of the second piezoelectric body 723c. All the thicknesses of the other layers are substantially the same. The thickness of each part in the third embodiment is defined such that the expression (3) described in the modification example of the first embodiment is satisfied. Since the thickness K3 of the first piezoelectric body 513c is thicker than the thickness J3 of the second piezoelectric body 723c, the neutral axis NA of the second piezoelectric element 723 is positioned higher than the neutral axis NA of the first piezoelectric element 513. As a result, similar to the first embodiment, in the pressurization portion 70C3, the first vibration plate 263 is easily vibrated by force generated by the first piezoelectric element 513, and in the vibration detection portion 70B3, strong force is transmitted to the second piezoelectric element 723 by the residual vibration received by the second vibration plate 293 from the ink, and the electromotive force can be efficiently generated. Therefore, the request for sufficiently increasing the pressure of the ink in the pressure chamber CC and for accurately detecting the residual vibration of the ink in the vibration detection chamber DB can be simultaneously satisfied. As a result, the throughput of ink ejection in the liquid ejecting head 10 can be sufficiently increased.

### D. Fourth Embodiment

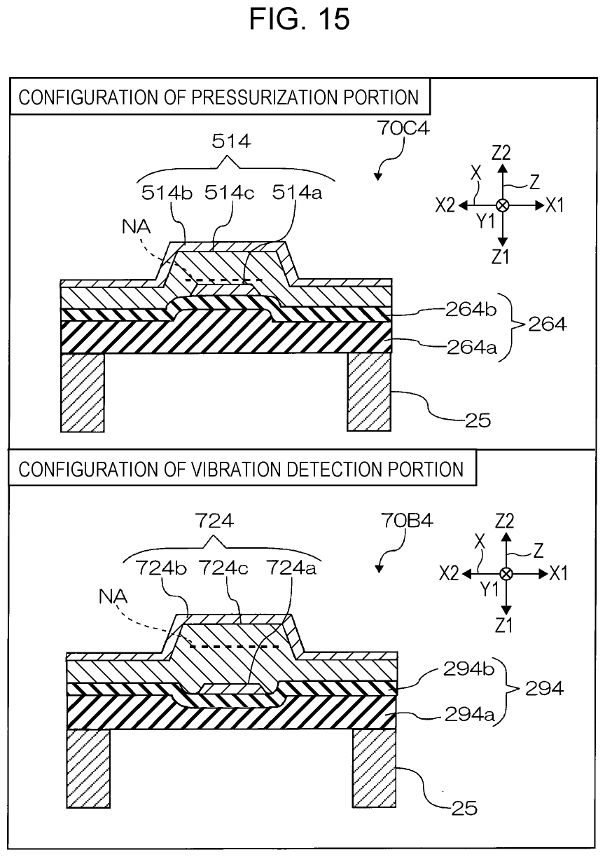

Next, a liquid ejecting head 10 of a fourth embodiment will be described. FIG. 15 is an explanatory diagram illustrating a comparison of a configuration of the vibration detection portion 70B4 and the pressurization portion 70C4 in the liquid ejecting head 10 according to the fourth embodiment. As illustrated in the drawing, the pressurization portion 70C4 is provided with a first piezoelectric element 514. The first piezoelectric element 514 includes a first vibration plate 264 at the lowest portion thereof in the Z direction. The first vibration plate 264 is configured by laminating a first elastic layer 264a and a first insulating layer 264b, similar to the first embodiment. On the other hand, the vibration detection portion 70B4 is provided with a second piezoelectric element 724. The second piezoelectric element 724 includes a second vibration plate 294 at the lowest portion thereof in the Z direction. The second vibration plate 294 is configured by laminating a second elastic layer 294a and an insulating layer 294b, similar to the first embodiment.

In the liquid ejecting head 10 of the fourth embodiment, the entire configuration is common to that of the first embodiment, but a method of making the height of the neutral axis NA of the second piezoelectric element 724 higher than the height of the neutral axis NA of the first piezoelectric element 514 is different. In the first embodiment, the height of the neutral axes of both is adjusted by making the thickness of the second insulating layer 29b and the first insulating layer 26b different from each other, but in the fourth embodiment, the shapes of the first vibration plate 264 and the second vibration plate 294 are different from each other, so that the height of the neutral axes of both is adjusted.

As illustrated in the drawing, the first piezoelectric element 514 is provided with a first lower electrode 51a, a first upper electrode 514b, a first piezoelectric body 514c, and a first vibration plate 264. In the first vibration plate 264, the first elastic layer 264a and the first insulating layer 264b are bonded to each other. The material and the like of each part of the first piezoelectric element 514 are the same as those of the first embodiment. The second piezoelectric element 724 is provided with a second lower electrode 724a, a second upper electrode 724b, a second piezoelectric body 724c, and a second vibration plate 294. In the second vibration plate 294, the second elastic layer 294a and the insulating layer 294b are bonded to each other. The material and the like of each part of the second piezoelectric element 724 are the same as those of the first embodiment.

In the fourth embodiment, unlike the first to third embodiments, the first vibration plate 264 in the pressurization portion 70C4 and the second vibration plate 294 in the vibration detection portion 70B4 are not flat, but are protruding in the Z2 direction at the position of the first piezoelectric body 514c, and are recessed (protruding in the Z1 direction) in the 22 direction at the position of the second piezoelectric body 724c, as illustrated in the drawing. The pressurization portion 70C4 and the vibration detection portion 70B4 all have substantially the same configuration except for this point. In the fourth embodiment, the first vibration plate 264 and the second vibration plate 294 have the illustrated shapes, and thus the neutral axis NA of the second piezoelectric element 724 is positioned higher than the neutral axis NA of the first piezoelectric element 514. As a result, similar to the first embodiment, in the pressurization portion 70C4, the first vibration plate 264 is easily vibrated by force generated by the first piezoelectric element 514, and in the vibration detection portion 70B4, strong force is transmitted to the second piezoelectric element 724 by the residual vibration received by the second vibration plate 294 from the ink, and the electromotive force can be efficiently generated. Therefore, the request for sufficiently increasing the pressure of the ink in the pressure chamber CC and for accurately detecting the residual vibration of the ink in the vibration detection chamber DB can be simultaneously satisfied. As a result, the throughput of ink ejection in the liquid ejecting head 10 can be sufficiently increased.

### E. Other Embodiments

1. In the first to third embodiments described above, in the pressurization portion and the vibration detection portion, the thickness of the insulating layer of the second vibration plate or the second piezoelectric body is thicker than the thickness of the insulating layer of the first vibration plate or the first piezoelectric body, or the thickness of the elastic layer of the second vibration plate is thinner than the thickness of the elastic layer of the first vibration plate. Therefore, the position of the neutral axis in the Z direction of the second piezoelectric element of the vibration detection portion is higher than the position of the neutral axis in the Z direction of the first piezoelectric element of the pressurization portion. As a result, in these embodiments, the first vibration plate is easily vibrated by the force generated by the first piezoelectric element of the pressurization portion, and in the vibration detection portion, the strong force is transmitted to the second piezoelectric element by the residual vibration received by the second vibration plate from the ink, and the electromotive force can be efficiently generated. Similar actions and effects can be obtained by the following embodiments.

In the liquid ejecting head 10 of the embodiment, using the thicknesses K1 to K3 and J1 to J3 of each part illustrated in FIGS. 9, 13, and 14, when a ratio of a sum of the thicknesses (K2+K1) of the first piezoelectric body and the first insulating layer to a thickness K3 of the first elastic layer is defined as a first ratio RK, a ratio of a sum of the thicknesses (J2+J1) of the second piezoelectric body and the second insulating layer to a thickness J3 of the second elastic layer is defined as a second ratio RJ, the second ratio RJ is greater than the first ratio RK, as illustrated in the following expression (4).

$$RJ > RK \qquad ( 4 )$$

$$Here , RJ = ( J 2 + J 1 ) / J 3 , RK = ( K 2 + K 1 ) / K 3$$

In this manner, the request for sufficiently increasing the pressure of the ink in the pressure chamber CC and for accurately detecting the residual vibration of the ink in the vibration detection chamber DB can be simultaneously satisfied.

2. In the first embodiment described above, the thickness of the first insulating layer 26b in the first vibration plate 26 and the thickness of the second insulating layer 29b in the second vibration plate 29 are different from each other, and in the third embodiment, the thickness of the first elastic layer 263a in the first vibration plate 263 and the thickness of the second elastic layer 293a in the second vibration plate 293 are different from each other. In these cases, when the thicknesses of the first piezoelectric bodies 51c and 513c and the second piezoelectric bodies 72c and 723c are substantially the same, it is not necessary to obtain the position of the neutral axis NS, and a ratio ja/jb of the thickness ja of the second elastic layer 29a and 293a to the thickness jb of the second insulating layer 29b and 293b in the vibration detection portions 70B and 70B3 may be smaller than a ratio ka/kb of the thickness ka of the first elastic layer 26a and 263a to the thickness kb of the first insulating layer 26b and 263b in the pressurization portions 70C and 70C3. In this manner, the request for sufficiently increasing the pressure of the ink in the pressure chamber CC and for accurately detecting the residual vibration of the ink in the vibration detection chamber DB can be simultaneously satisfied.

In addition, in the second embodiment described above, the thickness of the first piezoelectric body 512c in the first piezoelectric element 512 and the thickness of the second piezoelectric body 722c in the second piezoelectric element 722 are different from each other. In this case, when the thickness of the first insulating layer 262b and the thickness of the second insulating layer 292b, and the thickness of the first elastic layer 262a and the thickness of the second elastic layer 292a are substantially the same, it is not necessary to obtain the position of the neutral axis NS, and a ratio jc/jd of the thickness jc of the second piezoelectric body 722c to the thickness jd of the second vibration plate 292 in the vibration detection portion 70B2 may be greater than a ratio kc/kd of the thickness kc of the first piezoelectric body 512c to the thickness kd of the first vibration plate 262 in the pressurization portion 70C2. In this manner, the request for sufficiently increasing the pressure of the ink in the pressure chamber CC and for accurately detecting the residual vibration of the ink in the vibration detection chamber DB can be simultaneously satisfied.

3. In the liquid ejecting head 10 of the first embodiment, the thickness K1 of the first insulating layer 26b of the first vibration plate 26 and the thickness J1 of the second insulating layer 29b of the second vibration plate 29 are different from each other, but both are formed as one insulating layer having a thickness of J1 or more, and then manufactured by thinning to the thicknesses K1 and J1 by a method such as etching. Naturally, the first insulating layer 26b and the second insulating layer 29b may be formed as separate layers having each of the thicknesses K1 and J1, and then bonded or separated, and sealed at the joints to be interposed between the pressure chamber substrate 25 and the sealing plate 27. The first elastic layer 263a and the second elastic layer 293a of the third embodiment can also be manufactured by the same method.

4. In the first to fourth embodiments, the thickness and the shape of each layer are different, but the thickness and the shape of each layer may be the same, and the material and the physical properties may be different, so that the height of the neutral axis NA may be different. For example, when the second insulating layer 29b is formed of zirconium dioxide (ZrO₂), by changing the sintering temperature and the sintering time of the zirconium dioxide, the hardness thereof is made higher than that of the first insulating layer 26b, and thus, even when both have the same thickness, this is equivalent to the case where the second insulating layer 29b is thicker than the first insulating layer 26b, and the height of the neutral axis NA of the second piezoelectric element can be increased. Alternatively, the hardness may be similarly changed by changing the binder or the additive to realize the desired characteristics.

5. In the above configuration, as illustrated in FIG. 8, a wiring substrate 61 electrically coupled to the outside of the liquid ejecting head 10, for example, the control portion 20 of the liquid ejecting apparatus, a first wiring portion 54 that electrically couples the first piezoelectric element 51 to the wiring substrate 61, and a second wiring portion 74 that electrically couples the second piezoelectric element 72 to the wiring substrate 61 may be further provided. In this manner, one wiring substrate 61 can be used for wiring to the first piezoelectric element 51 and wiring to the second piezoelectric element 72.

6. In this configuration, the wiring substrate 61 may be positioned between the first piezoelectric element 51 and the second piezoelectric element 72 in the extending direction of the pressure chamber CC. In the first embodiment, the wiring substrate 61 is provided in the wiring introduction portion RC provided between the pressure chamber CC and the vibration detection chamber DB and such a configuration is realized. In this case, the first wiring portion 54 from the wiring substrate 61 to the first piezoelectric element 51 and the second wiring portion 74 from the wiring substrate 61 to the second piezoelectric element 72 are in opposite directions with the wiring substrate 61 interposed therebetween, and crosstalk between the first wiring portion 54 and the second wiring portion 74 is unlikely to occur. When a drive voltage for driving the first piezoelectric element 51 is applied to the first wiring portion 54, induction noise is not generated in the second wiring portion 74 or is prevented. Therefore, the accuracy of detecting the residual vibration by the vibration detection portion 70B can be improved.

7. In the above configuration, a third piezoelectric element 73 that is not electrically coupled to the wiring substrate 61, and an absorption chamber (damper chamber) DA that absorbs the residual vibration of the pressure applied in the pressure chamber CC by the third piezoelectric element 73 may be further provided. In this manner, the residual vibration is unlikely to propagate upstream when viewed from the pressure chamber CC, and the pressure fluctuation on upstream can be prevented. As a result, the pressure fluctuation of the ink flowing from upstream to the pressure chamber CC can be prevented, and the pressure applied to the nozzle N in the pressurization portion 70C can be controlled with high accuracy. It is preferable that the neutral axis NA of such a third piezoelectric element 73 is an intermediate height between the height (first height) of the neutral axis NA of the first piezoelectric element 51 and the height (second height) of the neutral axis NA of the second piezoelectric element 72.

8. In the above configuration, the third piezoelectric element 73 may include a third piezoelectric body 73c, a third upper electrode 73b provided above the third piezoelectric body 73c, a third lower electrode 73a provided below the third piezoelectric body 73c, and a third vibration plate 23 which is a third vibration plate provided below the third lower electrode 73a. In this manner, the configuration of the vibration absorption portion 70A can be configured with the same components and in the same assembly relationship as the vibration detection portion 70B and the pressurization portion 70C, and the manufacturing and maintenance can be facilitated.

In addition, in the liquid ejecting head 10 of each embodiment, since the third piezoelectric element 73 is provided on the third vibration plate 23, the third piezoelectric element 73 is deformed in accordance with the deformation of the third vibration plate 23, and the vibration of the ink in the damper chamber DA can be absorbed. In addition, by providing the third piezoelectric element 73 on the third vibration plate 23, the third vibration plate 23 can be reinforced.

9. In the above configuration, the second piezoelectric element 72, the wiring substrate 61, the first piezoelectric element 51, and the third piezoelectric element 73 may be disposed side by side in this order along the extending direction (X1 direction of each embodiment) of the pressure chamber CC. In this manner, not only the actions and effects of reducing the crosstalk described in above (6) can be obtained, but also the first piezoelectric element 51 and the third piezoelectric element 73 can be disposed close to each other, and thus it is possible to obtain the actions and effects superior to that of other dispositions in terms of the electric wiring and absorbing the pressure fluctuation, such as efficient absorption of pressure generated in the pressure chamber CC by the vibration absorption portion 70A.

10. In the above configuration, a common liquid chamber RA, which is a supply reservoir that supplies the liquid to the pressure chamber CC, and a common liquid chamber RB, which is a discharge reservoir that discharges the liquid from the pressure chamber CC, may be further provided, and the liquid may flow in this order of the common liquid chamber RA, the absorption chamber DA, the pressure chamber CC, the vibration detection chamber DB, which is the detection chamber, and the common liquid chamber RB, which is the discharge reservoir. In this manner, there is no unnecessary branching or retention point in the flow of the liquid, and the flow of the liquid can be made smooth. The nozzle N may be provided between the pressure chamber CC and the vibration detection chamber DB.

11. In the above configuration, a common liquid chamber RA, which is a supply reservoir that supplies the liquid to the pressure chamber CC, and a common liquid chamber RB, which is a discharge reservoir that discharges the liquid from the pressure chamber CC, may be further provided, and the liquid may flow in this order of the common liquid chamber RA, the vibration detection chamber DB, which is the detection chamber, the pressure chamber CC, the absorption chamber DA, and the common liquid chamber RB. In this manner, the pressure fluctuation propagating downstream the flow of the liquid from the pressure chamber CC can be quickly absorbed.

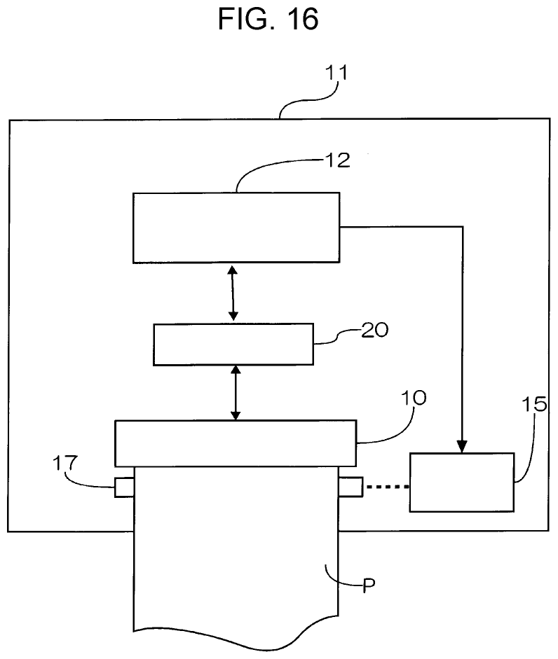

12. A liquid ejecting apparatus 11 can be easily realized by using the various liquid ejecting heads 10 described above and combining with the control portion 20 that controls an ejecting operation from the liquid ejecting head 10. FIG. 16 illustrates an example of a configuration of the liquid ejecting apparatus 11 as a printer that ejects ink to perform printing. The liquid ejecting apparatus 11 receives image data or the like from an image output apparatus (not illustrated) and prints the image data or the like on printing paper P as a printing medium mounted on the platen 17 by using the liquid ejecting head 10. The liquid ejecting apparatus 11 is configured as a line printer. The platen 17 is transported by the paper transport mechanism 15. The ECU 12 that controls the entire liquid ejecting apparatus 11 ejects ink from the liquid ejecting head 10 while transporting the printing paper P through the paper transport mechanism 15 or the control portion 20, and prints an image or the like on the printing paper P. Other members that constitute the printer are well known, and thus, illustration and description thereof will be omitted. Such a liquid ejecting apparatus can handle various liquids such as ink, water, alcohol, liquid fuel, and liquid medicine.

In each of the above embodiments, a part of the configuration realized by hardware may be replaced with software. At least a part of the configuration realized by the software can also be realized by a discrete circuit configuration. In addition, when a part or all of the functions of the present disclosure are realized by software, the software (computer program) can be provided in a form stored in a computer-readable recording medium. The term of “computer-readable recording medium” is not limited to a portable recording medium such as a flexible disk or a CD-ROM, and includes an internal storage device in a computer such as various RAMs and ROMs and an external storage device fixed to the computer such as a hard disk. That is, the term of “computer-readable recording medium” has a broad meaning including any recording medium on which a data packet can be fixed rather than temporarily.

The present disclosure is not limited to the above-described embodiments, and can be realized in various configurations within the scope not departing from the concept of the present disclosure. For example, technical features in the embodiments corresponding to technical features in each aspect described in a column of an outline of the disclosure can be appropriately replaced or combined to partially or entirely solve the above-described problems, or to partially or entirely obtain the above-described effects. In addition, unless the technical features are described as essential in the present specification, the technical features can be deleted as appropriate.

What is claimed is:

1. A liquid ejecting head comprising:
a nozzle;
a first piezoelectric element;
a pressure chamber that applies a pressure of a liquid for ejecting a liquid from the nozzle when the first piezoelectric element is driven;
a second piezoelectric element; and
a detection chamber in which the second piezoelectric element detects a residual vibration of the pressure of the liquid applied in the pressure chamber, wherein
the first piezoelectric element includes a first piezoelectric body, a first upper electrode provided above the first piezoelectric body, a first lower electrode provided below the first piezoelectric body, and a first vibration plate provided below the first lower electrode,
the second piezoelectric element includes a second piezoelectric body, a second upper electrode provided above the second piezoelectric body, a second lower electrode provided below the second piezoelectric body, and a second vibration plate provided below the second lower electrode, and
a neutral axis of the second piezoelectric element is positioned above a neutral axis of the first piezoelectric element.

2. The liquid ejecting head according to claim 1, wherein
the first vibration plate includes a first insulating layer and a first elastic layer provided below the first insulating layer,
the second vibration plate includes a second insulating layer and a second elastic layer provided below the second insulating layer, and
when a ratio of a sum of thicknesses of the first piezoelectric body and the first insulating layer to a thickness of the first elastic layer is defined as a first ratio, and a ratio of a sum of thicknesses of the second piezoelectric body and the second insulating layer to a thickness of the second elastic layer is defined as a second ratio, the second ratio is greater than the first ratio.

3. A liquid ejecting head comprising:
a nozzle;
a first piezoelectric element;
a pressure chamber that applies a pressure for ejecting a liquid from the nozzle when the first piezoelectric element is driven;
a second piezoelectric element; and
a detection chamber in which the second piezoelectric element detects a residual vibration of the pressure applied in the pressure chamber, wherein
the first piezoelectric element includes a first piezoelectric body, a first upper electrode provided above the first piezoelectric body, a first lower electrode provided below the first piezoelectric body, and a first vibration plate provided below the first lower electrode,
the second piezoelectric element includes a second piezoelectric body, a second upper electrode provided above the second piezoelectric body, a second lower electrode provided below the second piezoelectric body, and a second vibration plate provided below the second lower electrode,
the first vibration plate includes a first insulating layer and a first elastic layer provided below the first insulating layer,
the second vibration plate includes a second insulating layer and a second elastic layer provided below the second insulating layer, and
when a ratio of a sum of thicknesses of the first piezoelectric body and the first insulating layer to a thickness of the first elastic layer is defined as a first ratio, and a ratio of a sum of thicknesses of the second piezoelectric body and the second insulating layer to a thickness of the second elastic layer is defined as a second ratio, the second ratio is greater than the first ratio.

4. The liquid ejecting head according to claim 2, wherein
the second insulating layer is thicker than the first insulating layer.

5. The liquid ejecting head according to claim 2, wherein
the second piezoelectric body is thicker than the first piezoelectric body.

6. The liquid ejecting head according to claim 2, wherein
the second elastic layer is thinner than the first elastic layer.

7. The liquid ejecting head according to claim 2, wherein
the first piezoelectric body, the second piezoelectric body, the first insulating layer, and the second insulating layer have tensile stress, and
the first elastic layer and the second elastic layer have compressive stress.

8. The liquid ejecting head according to claim 2, further comprising:
a wiring substrate that is electrically coupled to an outside of the liquid ejecting head;
a first wiring portion that electrically couples the first piezoelectric element and the wiring substrate; and
a second wiring portion that electrically couples the second piezoelectric element and the wiring substrate.

9. The liquid ejecting head according to claim 8, wherein
the wiring substrate is positioned between the first piezoelectric element and the second piezoelectric element in an extending direction of the pressure chamber.

10. The liquid ejecting head according to claim 8, further comprising:
a third piezoelectric element that is not electrically coupled to the wiring substrate; and
an absorption chamber in which the third piezoelectric element absorbs the residual vibration of the pressure applied in the pressure chamber.

11. The liquid ejecting head according to claim 10, wherein
the third piezoelectric element includes a third piezoelectric body, a third upper electrode provided above the third piezoelectric body, a third lower electrode provided below the third piezoelectric body, and a third vibration plate provided below the third lower electrode.

12. The liquid ejecting head according to claim 11, wherein
a neutral axis of the third piezoelectric element is positioned above the neutral axis of the first piezoelectric element and below the neutral axis of the second piezoelectric element.

13. The liquid ejecting head according to claim 10, wherein
the second piezoelectric element, the wiring substrate, the first piezoelectric element, and the third piezoelectric element are disposed side by side in this order in an extending direction of the pressure chamber.

14. The liquid ejecting head according to claim 10, further comprising:
a supply reservoir that supplies a liquid to the pressure chamber; and
a discharge reservoir that discharges the liquid from the pressure chamber, wherein
the liquid flows in this order of the supply reservoir, the absorption chamber, the pressure chamber, the detection chamber, and the discharge reservoir.

15. The liquid ejecting head according to claim 10, further comprising:
a supply reservoir that supplies a liquid to the pressure chamber; and
a discharge reservoir that discharges the liquid from the pressure chamber, wherein
the liquid flows in this order of the supply reservoir, the detection chamber, the pressure chamber, the absorption chamber, and the discharge reservoir.

16. A liquid ejecting apparatus comprising:
the liquid ejecting head according to claim 1; and a control portion that controls an ejecting operation from the liquid ejecting head.
